(19) United States
(12) Patent Application Publication
(10) Pub. No.: US 2026/0088856 A1
(43) Pub. Date: Mar. 26, 2026

(54) RECONFIGURABLE INTELLIGENT SURFACE/RECONFIGURABLE HOLOGRAPHIC SURFACEBASED JOINT PRECODING, BEAMFORMING, AND MODULATION

(71) Applicant: InterDigital Patent Holdings, Inc., Wilmington, DE (US)

(72) Inventors: Ibrahim Hemadeh, Hemel Hempstead (GB); Allan Yingming Tsai, Boonton, NJ (US); Qingchao Li, Southampton (GB); Mohammed El-Hajjar, Southampton (GB); Arman Shojaeifard, London (GB); Deepa Gurmukhdas Jagyasi, London (GB)

(73) Assignee: InterDigital Patent Holdings, Inc., Wilmington, DE (US)

(21) Appl. No.: 19/106,901

(22) PCT Filed: Aug. 29, 2023
(86) PCT No.: PCT/US2023/031366

§ 371 Date: Feb. 26, 2025

Related U.S. Application Data
(60) Provisional application No. 63/402,548, filed on Aug. 31, 2022.
(60) Provisional application No. 63/429,345, filed on Dec. 1, 2022.
(60) Provisional application No. 63/526,234, filed on Jul. 12, 2023.

(51) Int. Cl. H04B 7/04; H04B 7/06

(52) U.S. Cl. CPC H04B 7/04013; H04B 7/0626

(57) ABSTRACT

A wireless transmit/receive unit (WTRU) may receive a channel state information reference signal (CSI-RS) from a transmitter (e.g., via a reconfigurable intelligent surface (RIS)). The transmitter may be associated with the RIS. The WTRU may determine, based on the CSI-RS, channel information (e.g., channel vector information) associated with a first subset of elements of the RIS. The WTRU may determine, based on the channel information associated with the first subset of elements of the RIS, channel information (e.g., channel vector information) associated with a second subset of elements of the RIS. The WTRU may generate a CSI reporting parameter based on the channel information associated with the second subset of elements of the RIS. The WTRU may send the CSI reporting parameter. The WTRU may generate the CSI reporting parameter using a channel matrix associated with the RIS. The CSI reporting parameter may be a virtual CSI reporting parameter.

### CROSS-REFERENCE TO RELATED APPLICATIONS

This application claims the benefit of Provisional U.S. Patent Application No. 63/402,548, filed Aug. 31, 2022, Provisional U.S. Patent Application No. 63/429,345, filed Dec. 1, 2022, and Provisional U.S. Patent Application No. 63/526,234, filed Jul. 12, 2023, the disclosure of which is incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with generating a CSI reporting parameter based on channel information associated with a reconfigurable intelligent surface (RIS).

In examples, a wireless transmit/receive unit (WTRU) may receive a channel state information reference signal (CSI-RS) from a transmitter (e.g., via a reconfigurable intelligent surface (RIS)). The transmitter (e.g., a RIS-based transmitter) may be associated with the RIS. The WTRU may determine, based on the CSI-RS, channel information (e.g., channel vector information) associated with a first subset of elements of the RIS. The WTRU may determine, based on the channel information associated with the first subset of elements of the RIS, channel information (e.g., channel vector information) associated with a second subset of elements of the RIS. The WTRU may generate a CSI reporting parameter based on the channel information associated with the second subset of elements of the RIS. The WTRU may send the CSI reporting parameter.

The WTRU may generate the CSI reporting parameter using a channel matrix associated with the RIS. In examples, the WTRU may determine the channel matrix associated with the RIS, for example, based on the channel information associated with the first subset of elements of the RIS and/or the channel information associated with the second subset of elements of the RIS. The channel matrix may include the channel information associated with the first subset of elements of the RIS and/or the channel information associated with the second subset of elements of the RIS. The WTRU may generate the CSI reporting parameter using the channel matrix associated with the RIS.

The CSI reporting parameter may be a virtual CSI reporting parameter. In examples, the WTRU may receive configuration information associated with the RIS. The configuration information associated with the RIS may indicate a configuration associated with the first subset of elements of the RIS and/or a configuration associated with the second subset of elements of the RIS. The WTRU may determine a first channel matrix based on the channel information associated with the first subset of elements of the RIS. The WTRU may determine a second channel matrix based on the first channel matrix and the configuration information. The second channel matrix may include the channel information associated with the first subset of elements of the RIS and the channel information associated with the second subset of elements of the RIS. The WTRU may generate the virtual CSI reporting parameter using the second channel matrix. In some examples, the first channel matrix may include a first channel matrix coefficient that indicates channel information (e.g., channel vector information) associated with an element of the first subset of elements of the RIS. The second channel matrix may include the first channel matrix coefficient and a second channel matrix coefficient that indicates channel information (e.g., channel vector information) associated with an element of the second subset of elements of the RIS.

In examples, the configuration information associated with the RIS may indicate an active element of the RIS and/or an inactive element of the RIS. The CSI-RS that the WTRU uses to determine the channel information associated with the first subset of elements of the RIS may be associated with the active element of the RIS. For example, the configuration information associated with the RIS may indicate that the first subset of elements includes one or more active elements (e.g., including the active element associated with the CSI-RS) of the RIS and/or that the second subset of elements includes one or more inactive elements of the RIS.

The WTRU may determine another CSI reporting parameter based on channel measurements. In examples, the WTRU may perform, based on one or more CSI-RSs, the channel measurements. The channel measurements may be limited to the first subset of elements of the RIS (e.g., the channel measurements may be limited to one or more CSI-RSs associated with the active elements of the RIS). The WTRU may use the channel measurements to determine a CSI reporting parameter, for example, in addition to the virtual CSI reporting parameter, and/or to determine the channel information associated with the first subset of elements of the RIS. In examples, the WTRU may determine the virtual channel reporting parameter and/or another channel reporting parameter and send at least one of the virtual channel reporting parameter and/or another channel reporting parameter.

The WTRU may generate the CSI reporting parameter further based on block division information associated with the RIS. In examples, the WTRU may receive the block division information associated with the RIS (e.g., in the configuration information associated with the RIS). The block division information may indicate that the RIS includes a first block of elements and a second block of elements. The first block of elements may include the first subset of elements and the second subset of elements. The first subset of elements may include an active element associated with the first block of elements, and the second subset of elements may include an inactive element associated with the first block of elements. The CSI reporting parameter that the WTRU generates based on the block division information may be associated with the first block of elements.

The WTRU may send and/or receive a RIS-based transmission. In examples, the WTRU may receive a request to communicate using a RIS-based transmission. The WTRU may receive an indication of one or more transmission ports, for example, after the WTRU sends the CSI reporting parameter to a base station. The WTRU may decode the RIS-based transmission based on the indication of one or more transmission ports.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example architecture associated with a RIS-based information transfer.

FIG. 3 shows an example of hybrid beamforming architecture and ports (e.g., antenna ports and/or logical antenna ports).

FIG. 4 shows examples of antenna ports configurations of (N1, N2) that may be used in one or more examples as described herein: FIG. 4(a) shows a 16×1 configuration; FIG. 4(b) shows a 8×2 configuration; FIG. 4(c) shows a 4×4 configuration.

FIG. 5 shows an example of an in-phase and quadrature-phase (IQ) modulator.

FIG. 6 shows an example of a direct conversion/zero-IF architecture.

FIG. 7 shows an example of a RIS-based transmitter (e.g., a RIS-based multi-user transmitter).

FIG. 8 shows an example of a RHS-based transmitter (e.g., a RHS-based multi-user transmitter).

FIG. 9 shows an example of a relationship between a reflection coefficient (e.g., the reflection coefficient φₙ, where φₙ=βₙe^{j2πθ}^{ₙ}) and a configurable load impedance (e.g., the configurable load impedance

$${Z}_{L}^{( n )} ,$$

where

$${Z}_{L}^{( n )} = {R}_{L}^{( n )} + j {X}_{L}^{( n )} ) .$$

FIG. 10 shows an example RIS/RHS-based transmission (e.g., an example RIS/RHS-based multi-user transmission).

FIG. 11 shows an example RIS/RHS controller (e.g., a RIS/RHS controller that tunes the RIS/RHS elements using the phase and amplitude information of x).

FIG. 12 shows an example block diagram of CP-OFDM.

FIG. 13 shows an example of a theoretical and simulation comparison of spectral efficiency versus transmit power for MIMO (e.g., the conventional MIMO) in LOS channels and the RIS-based single-RF downlink information transfer system in Rayleigh channels.

FIG. 14 shows an example of a theoretical and simulation comparison of symbol error probability versus transmit power Es for MIMO (e.g., the conventional MIMO) in LOS channels and the RIS-based single-RF downlink information transfer system in Rayleigh channels.

FIG. 15 shows an example of the relationship between the number of RF chains (N_{RF}) in some MIMO systems (e.g., conventional MIMO systems) and the number of RIS elements (N) in the RIS-aided single-RF information transfer scheme when the same ergodic rate is achieved.

FIG. 16 shows an example of a simulation comparison of sum rate Rₛᵤₘ, minimum rate Rₘᵢₙ, geometric-mean rate R_{GM} versus average receive SINR ρ (e.g., when considering different power allocation techniques).

FIG. 17 shows an example of a simulation comparison of sum rate Rₛᵤₘ, minimum rate Rₘᵢₙ, geometric-mean rate R_{GM} versus average receive SINR ρ, for different channel correlation values (e.g., where the maximizing sum-rate technique is employed for the calculation of sum rate, the maximizing min-rate technique is employed for the calculation of minimum rate, and the maximizing geometric-mean-rate technique is employed for the calculation of geometric-mean rate).

FIG. 18 shows an example of a simulation comparison of sum rate Rₛᵤₘ, minimum rate Rₘᵢₙ, geometric-mean rate R_{GM} versus the number of RIS elements N for different power allocation techniques (e.g., where the average receive SINR ρ=−25 dB).

FIG. 19 shows an example of a simulation comparison of symbol error probability Pₑ versus average receive SINR ρ of various power allocation techniques (e.g., the three power allocation techniques as described in one or more examples herein).

FIG. 20 shows an example of comparison of BER performance versus average received SNR p with different modulation schemes (e.g., where the number of users K=4 and the number of RIS elements N=256).

FIG. 21 shows an example of comparison of BER performance versus average received SNR p with different numbers of users K (e.g., where the number of RIS elements is N=256 and the modulation schemes are 16-PSK and 16-QAM, respectively).

FIG. 22 shows an example of comparison of BER performance versus average received SNR p with different numbers of RIS elements N (e.g., where the number of users is K=4 and the modulation schemes are 16-PSK and 16-QAM, respectively).

FIG. 23 shows an example of comparison of BER performance versus average received SNR p in a RIS-based transmitter and an MIMO example (e.g., the conventional massive MIMO), where the number of users is K=1 and the modulation schemes are 16-PSK and 16-QAM, respectively.

FIG. 24 shows an example of dividing a RIS/RHS array into blocks for CSI-RS transmission(s).

FIG. 25 shows an example of determining and reporting a CSI report and/or V-CSI report.

FIG. 26 shows an example for a port allocation associated with RIS-based transmission(s).

### DETAILED DESCRIPTION

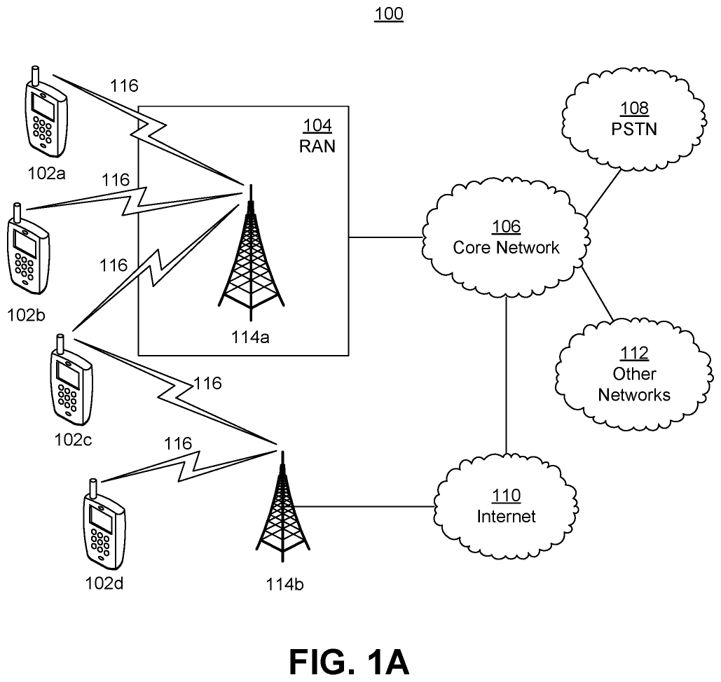

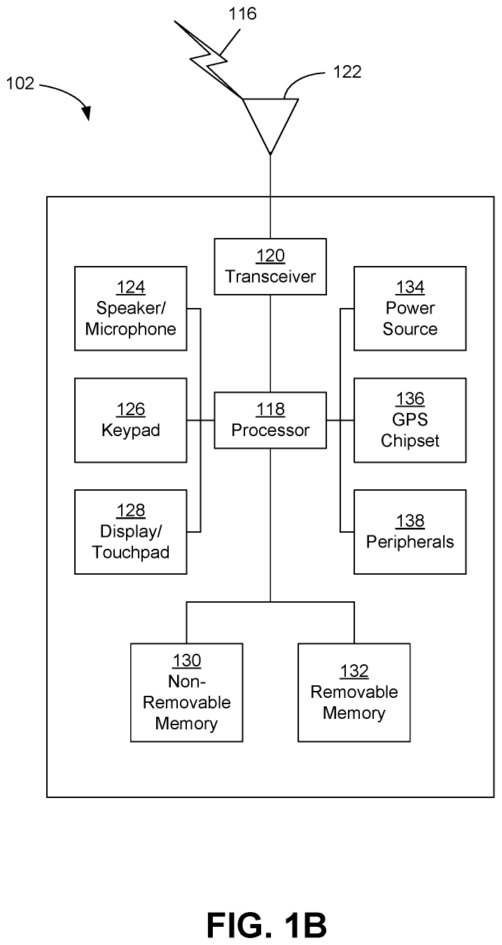

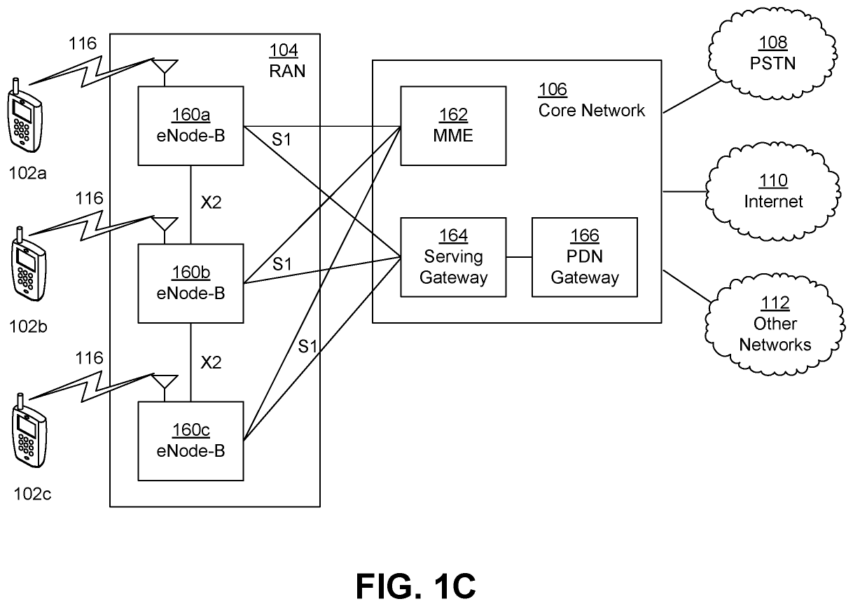

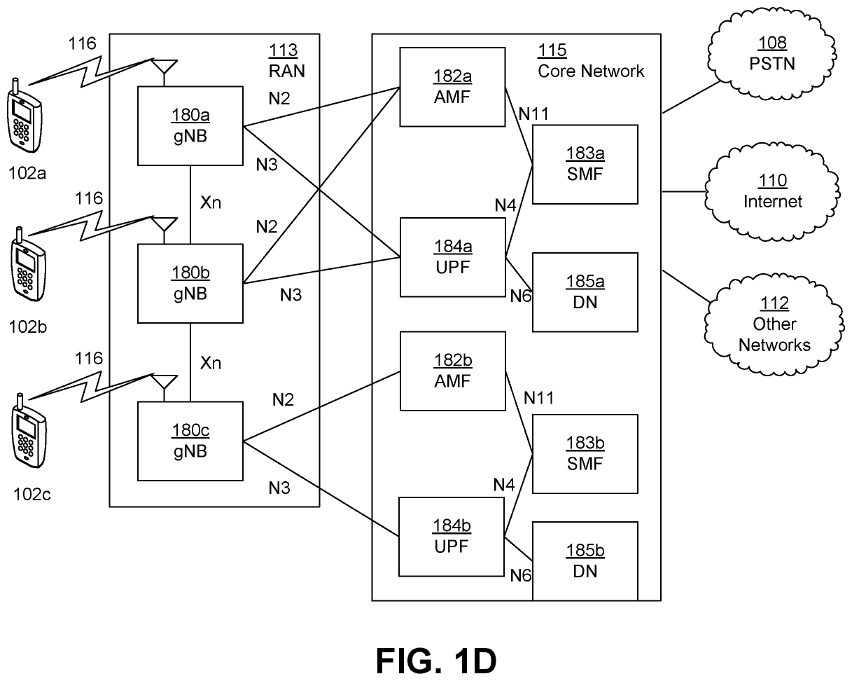

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein associated with reconfigurable intelligent surface (RIS)/reconfigurable holographic surface (RHS)-based join precoding, beamforming, and modulation. A RIS/RHS-based joint multi-user precoding and modulation may be provided, which is digitally processed and nondigitally deployed (e.g., using RIS/RHS elements). The transmission scheme may allow an IQ-based constellation (e.g., any in-phase and quadrature-phase (IQ)-based constellation such as quadrature amplitude modulation (QAM) and/or amplitude and phase-shift keying (APSK)) and OFDM transmission without peak-to-average power ratio (PAPR). Per user RIS/RHS elements power allocation may be used with an optimization technique. The OFDM transmission may not be limited with the number of resources, for example, unlike the classical hybrid beamforming architectures that are limited by the transceiver unit (TXRU). Orthogonal frequency-division multiplexing (OFDM) modulation with per subcarrier precoding may be used, for example, to achieve bit error rate (BER) performance and average received signal-to-noise ratio (SNR) in one or more examples herein, for quadrature amplitude modulation (QAM) and phase-shift keying (PSK) modulations. In examples, a WTRU may receive a symbol to transmit to a device and/or configure elements (e.g., RIS/RHS elements) to transmit the symbol (e.g., QAM symbol). A respective element may be set with a respective phase shift and/or a respective amplitude. A total amplitude associated with the elements may be related to a scaling factor associated with the elements.

Dynamic resource allocation may be performed for RIS-based transmission(s). A wireless transmit/receive unit (WTRU) may receive configuration information that may indicate one or more of: the maximum number of channel state information reference signal (CSI-RS) and/or demodulation reference signal (DMRS) ports supported; port resources (e.g., antenna port resources in time and/or frequency domain). The WTRU may estimate a full array of ports (e.g., virtual antenna ports) based on Tx CSI-RS port(s), for example, to compute and/or report virtual CSI (e.g., including one or more of virtual channel quality indication (V-CQI), virtual precoding matrix indicator (V-PMI), virtual rank indicator (V-RI), virtual layer indicator (V-LI), etc.). The WTRU may be dynamically configured for physical downlink shared channel (PDSCH) transmission(s) with DMRS ports.

Systems, methods, and instrumentalities are disclosed herein associated with generating a CSI reporting parameter based on channel information associated with a reconfigurable intelligent surface (RIS).

In examples, a wireless transmit/receive unit (WTRU) may receive a channel state information reference signal (CSI-RS) from a transmitter (e.g., via a reconfigurable intelligent surface (RIS)). The transmitter may be associated with the RIS. The WTRU may determine, based on the CSI-RS, channel information (e.g., channel vector information) associated with a first subset of elements of the RIS. The WTRU may determine, based on the channel information associated with the first subset of elements of the RIS, channel information (e.g., channel vector information) associated with a second subset of elements of the RIS. The WTRU may generate a CSI reporting parameter based on the channel information associated with the second subset of elements of the RIS. The WTRU may send the CSI reporting parameter.

The WTRU may generate the CSI reporting parameter using a channel matrix associated with the RIS. In examples, the WTRU may determine the channel matrix associated with the RIS, for example, based on the channel information associated with the first subset of elements of the RIS and/or the channel information associated with the second subset of elements of the RIS. The channel matrix may include the channel information associated with the first subset of elements of the RIS and/or the channel information associated with the second subset of elements of the RIS. The WTRU may generate the CSI reporting parameter using the channel matrix associated with the RIS.

The CSI reporting parameter may be a virtual CSI reporting parameter. In examples, the WTRU may receive configuration information associated with the RIS. The configuration information associated with the RIS may indicate a configuration associated with the first subset of elements of the RIS and/or a configuration associated with the second subset of elements of the RIS. The WTRU may determine a first channel matrix based on the channel information associated with the first subset of elements of the RIS. The WTRU may determine a second channel matrix based on the first channel matrix and the configuration information. The second channel matrix may include the channel information associated with the first subset of elements of the RIS and the channel information associated with the second subset of elements of the RIS. The WTRU may generate the virtual CSI reporting parameter using the second channel matrix. In some examples, the first channel matrix may include a first channel matrix coefficient that indicates channel information (e.g., channel vector information) associated with an element of the first subset of elements of the RIS. The second channel matrix may include the first channel matrix coefficient and a second channel matrix coefficient that indicates channel information (e.g., channel vector information) associated with an element of the second subset of elements of the RIS.

In examples, the configuration information associated with the RIS may indicate an active element of the RIS and/or an inactive element of the RIS. The CSI-RS that the WTRU uses to determine the channel information associated with the first subset of elements of the RIS may be associated with the active element of the RIS. For example, the configuration information associated with the RIS may indicate that the first subset of elements includes one or more active elements (e.g., including the active element associated with the CSI-RS) of the RIS and/or that the second subset of elements includes one or more inactive elements of the RIS.

The WTRU may determine another CSI reporting parameter based on channel measurements. In examples, the WTRU may perform, based on one or more CSI-RSs, the channel measurements. The channel measurements may be limited to the first subset of elements of the RIS (e.g., the channel measurements may be limited to one or more CSI-RSs associated with the active elements of the RIS). The WTRU may use the channel measurements to determine a CSI reporting parameter, for example, in addition to the virtual CSI reporting parameter, and/or to determine the channel information associated with the first subset of elements of the RIS. In examples, the WTRU may determine the virtual channel reporting parameter and/or another channel reporting parameter and send at least one of the virtual channel reporting parameter and/or another channel reporting parameter.

The WTRU may generate the CSI reporting parameter further based on block division information associated with the RIS. In examples, the WTRU may receive the block division information associated with the RIS (e.g., in the configuration information associated with the RIS). The block division information may indicate that the RIS includes a first block of elements and a second block of elements. The first block of elements may include the first subset of elements and the second subset of elements. The first subset of elements may include an active element associated with the first block of elements, and the second subset of elements may include an inactive element associated with the first block of elements. The CSI reporting parameter that the WTRU generates based on the block division information may be associated with the first block of elements.

The WTRU may send and/or receive a RIS-based transmission. In examples, the WTRU may receive a request to communicate using a RIS-based transmission. The WTRU may receive an indication of one or more transmission ports, for example, after the WTRU sends the CSI reporting parameter to a base station. The WTRU may decode the RIS-based transmission based on the indication of one or more transmission ports.

Reconfigurable intelligent surfaces (RISs) may be used in one or more examples as described herein. RIS(s) may be implemented in wireless communication systems. RIS(s) may be capable of adapting the radio environment conditions by electronically controlling the propagation of impinging signal(s) on the surface, for example, for improving the received signal strength and/or spectral efficiency. The surface(s) (e.g., RIS(s)) may include array(s) of elements (e.g., large array(s) of low-cost and energy-efficient elements). The elements may include meta-surfaces and/or reflection-arrays. In examples, the elements may be passive and/or do not require dedicated energy source(s).

RIS(s) may have a range of applications, for example, in the internet of things (IoT) networks, including one or more of the following designing beamforming for mmWave communication systems to increase communication reliability, constructing physical layer security networks, providing simultaneous wireless information and power transfer (SWIPT), or being employed for localization, positioning, sensing and mobile edge computing. RIS may be deployed (e.g., as a transmitter, for example, in association with a RIS-based transmitter) to modulate signals, which may have application(s) in the wireless communications (e.g., due to the low hardware complexity compared with conventional massive MIMO systems). For example, in some massive MIMO systems, a large number of RF-chains may be required to modulate signals, while in an RIS-aided information transfer scheme, information may be modulated on a passive RIS by configuring the reflection coefficient of an (e.g., each) element, which may be used as an energy-efficient and/or cost-efficient architecture (e.g., hardware architecture).

RIS-based modulation(s) may be described herein. Employing RIS (e.g., as a transmitter, for example, in association with a RIS-based transmitter) may realize information modulation with a low hardware complexity for wireless communication scenarios.

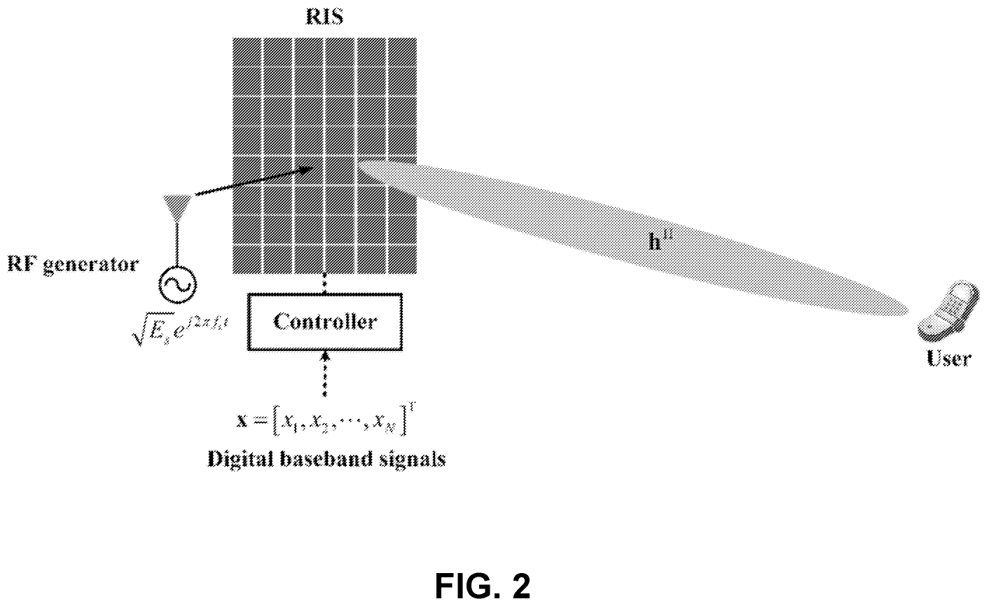

FIG. 2 shows an example architecture associated with a RIS-based information transfer. A RIS-based information transfer architecture supporting a single user may be shown in FIG. 2, where a single RF chain may generate an unmodulated sine carrier wave, with power Eₛ and frequency f_{c}, impinging on the N-element passive RIS. The RIS controller may convert the precoded digital baseband signals x=[x₁ x₂ . . . x_{N}]^{T} into analogue electrical signals to control the reflection coefficient, including the amplitude and phase shift, of a RIS element (e.g., each RIS reflecting element). A RIS-based information transfer system (e.g., the RIS-based information transfer system shown in FIG. 2) may be associated with a low hardware complexity (e.g., compared with some systems, for example, the conventional massive MIMO systems, the RIS-based information transfer system may have lower hardware complexity). In some examples (e.g., conventional massive MIMO systems), the baseband signals from a digital precoder may be converted to RF signals by multiple active RF chains and/or radiated from multiple transmit antennas. In a RIS-based information transfer system, one RF chain may be used to empower the RIS, and the precoded digital baseband signals may be passively modulated on a RIS element (e.g., in the RIS-based information transfer system, only one RF chain may be required to empower the RIS, and the precoded digital baseband signals may be passively modulated on each RIS element, which may result in a virtual MIMO wireless communication system with considerably lower hardware complexity).

In a RIS-aided single-user information transfer system, a RIS may be empowered, for example, by a single antenna with unmodulated carrier signals, and/or information may be conveyed via controlling the phase shift of a RIS element (e.g., each passive RIS element). Given the channel state information (CSI) (e.g., received from one or more users via CSI reports), the phase of the RIS elements (e.g., all RIS elements) may be adjusted coherently to maximize the received signal-to-noise ratio (SNR), where M-level phase shifts may be modulated on the reflected signals from the RIS elements (e.g., all RIS elements) to create an M-phase shift keying (PSK) signal constellation.

In some examples (e.g., an example system with a setup similar to the RIS-aided single-user information transfer system), a blind access point-RIS modulation scheme may be employed for the RIS-aided single-user information transfer without CSI. A binary phase shift (e.g., 0 and π), may be configured on the RIS elements (e.g., all RIS elements) to create a binary phase shift keying (BPSK) constellation. The blind access point-RIS modulation scheme may cut down the channel estimation overhead (e.g., compared with the RIS-aided single-user information system), and, in some cases, at the cost of performance loss.

Employing RIS to realize Alamouti scheme may be used, where a single RF unmodulated signal generator empowers the RIS, and the RIS is divided into two blocks, with Alamouti scheme designed based on configuring the phase shift of the RIS elements. A transmit diversity (e.g., a transmit diversity of order two) may be achievable by the RIS-aided modulation scheme.

A RIS-based index modulation scheme may be constructed, where the RIS is deployed between a single RF-chain and a multi-antenna receiver. Two information transfer techniques may be used, for example, RIS-aided space shift keying (SSK) and RIS-aided spatial modulation (SM). In the RIS-aided SSK, the signals radiated from the RF-chain may be unmodulated, and information may be conveyed (e.g., only conveyed) on the specific receiver antenna. The phase shift of the RIS element (e.g., each RIS element) may be configured to design the beamforming from the RIS to the selected receiver antenna. In the RIS-aided SM, the signal in the single RF-chain may be modulated, and information may be conveyed via both the modulated signals on the RF-chain and the selected receiver antenna. At the receiver, the greedy detector and maximum likelihood (ML) detector may be employed for recovering information.

A RIS-aided receive quadrature reflecting modulation (RIS-RQRM) scheme may be used (e.g., to increase throughput), where a RIS (e.g., the whole RIS) may be divided into two halves which create signals with in-phase and quadrature components, respectively. The information may be conveyed via a half (e.g., each half) of the RIS, for example, to form a beam to a specific antenna at the receiver.

RIS-aided modulation may have a wide application (e.g., due to its energy-efficiency and cost-effective hardware architecture), for example, by realizing information modulation based on configuring the reflection coefficient(s) of the RIS elements empowered by a single carrier generator.

In examples, a single-user RIS-aided PSK modulation architecture may be used, where an 8-PSK signal constellation is realized by configuring the phase shift of 8×32 RIS elements, which may achieve 6.144 Mbps data rate at 4.25 GHz carrier frequency. The hardware complexity may be low (e.g., extremely low since only a single RF-chain is required). There may be some performance differences from some systems (e.g., conventional active transmitters).

RIS may be applied for wireless communications with a large aperture (e.g., UM-MIMO and holographic MIMO), for example, due to its low hardware complexity. Quadrature amplitude modulation (QAM) may be designed based on independently controlling the amplitude and phase shift of a RIS element (e.g., each RIS element), for example, by introducing a non-linear modulation technique to realize a high-order modulation under the constraint of constant envelop. A varactor-diode-based RIS may be employed for a point-to-point 2×2 MIMO-QAM wireless system. The cost-effective hardware architecture and/or the wide application of RIS-aided modulation schemes may be shown by realizing a real-time RIS-based Alamouti space-time transmission.

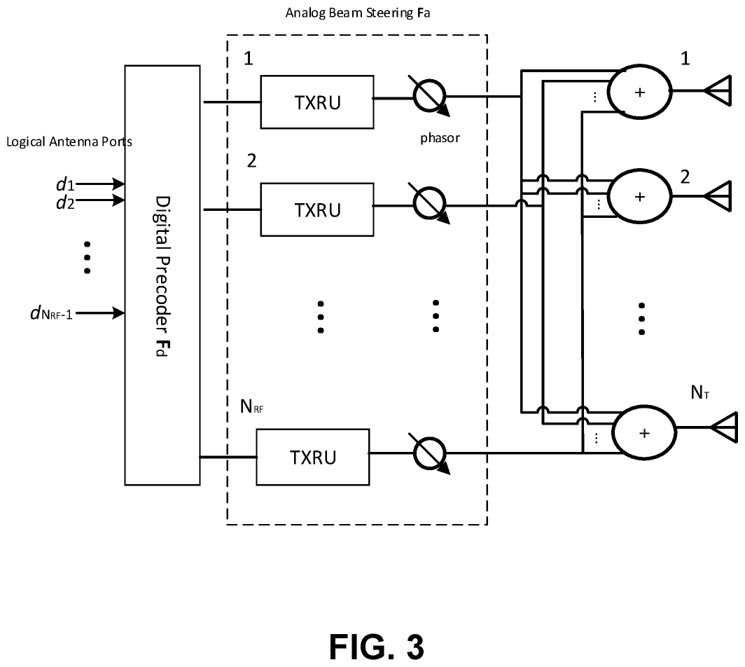

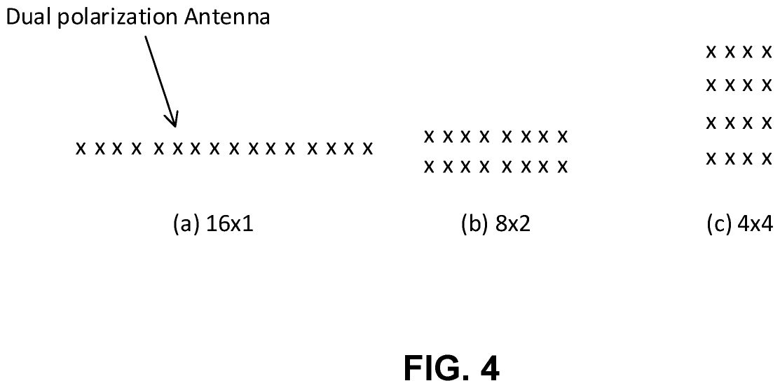

FIG. 3 shows an example of hybrid beamforming architecture and ports (e.g., antenna ports and/or logical antenna ports). FIG. 4 shows examples of antenna ports configurations of (N1, N2) that may be used in one or more examples as described herein: FIG. 4(a) shows a 16×1 configuration; FIG. 4(b) shows a 8×2 configuration; FIG. 4(c) shows a 4×4 configuration. One or more features of a hybrid beamforming architecture (e.g., the hybrid beamforming architecture shown in FIG. 3) may be used in one of more examples as described herein. Various numbers of ports (e.g., various numbers of logic antenna ports used in NR) may be used in one or more examples as described herein. The number of ports (e.g., the number of logic antenna ports) P may be {4, 8, 16, 32}, as used in the example shown in FIG. 3. In FIG. 3, N_{T} may be used to denote the number of antenna elements, N_{RF} may be used to denote the number of RF chains, and dN_{RF} (d_N_{RF}) may be used to denote the total number of ports (e.g., 32).

The number of ports (e.g., logical antenna ports) may be mapped to different antenna ports configuration (e.g., (N₁,N₂) in a single panel). An antenna configuration may be mapped to one or more ports (e.g., one or more CSI-RS ports). For example, 32 ports (e.g., assuming a dual polarization, and the number of dual polarized CSI-RS ports P=(2N₁N₂)) may be mapped to antenna configuration with (N₁,N₂)=(16,1), (8,2) and (4, 4), as shown in FIG. 4.

In examples, DL transmission may be based on non-codebook-based precoding schemes. A precoder may be associated with a precoder matrix indicator (PMI) used by a WTRU as part of CSI estimation based on one or more CSI-RSs (e.g., a precoder may be used for the precoder matrix indicator (PMI) for a WTRU to estimate CSI). Multiple (e.g., two) types of precoders may be supported. Multiple report types (e.g., a report type associated with Type-I CSI and a report type associated with Type-Il CSI) may be used. For example, a first type of precoder may be associated with a first report type associated with Type-I CSI and a second type of precoder may be associated with a second report type associated with Type-Il CSI (e.g., two types of precoders are supported, one may be Type-I CSI and the other may be Type-Il CSI, respectively). Type-I CSI (e.g., a report type having a standard resolution) may be optimized, for example, for single user MIMO (SU-MIMO) transmission(s) with a potentially large (e.g., up to 8) number of layers. Type-Il CSI (e.g., a report type having a high resolution) may be optimized, for example, for multi-user MIMO (MU-MIMO) transmission(s) (e.g., with up to 2 layers per scheduled WTRU and an overall maximum number of 12 layers). Type I and Type II (e.g., Type I and Type II codebooks, for example, codebook-based CSI feedback(s) may be constructed from two-dimension (2D) DFT-based grid of beams and/or enable the CSI feedback of beam selection(s) (e.g., as well as PSK-based co-phase combining between two polarizations). Type II (e.g., Type II codebook-based CSI feedback) may report the wideband and subband amplitude information of the selected beam(s).

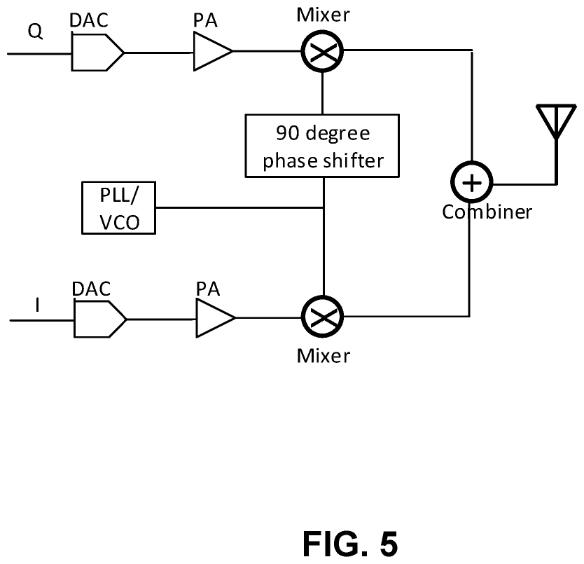

FIG. 5 shows an example of an in-phase and quadrature-phase (IQ) modulator. The IQ modulator may provide a technique for modulating data (e.g., symbols) onto a RF carrier. The IQ modulator (e.g., upconversion) may be an architecture for implementing transmitters in wireless applications.

The in-phase and quadrature-phase signals may be upconverted to RF frequency using the mixers (e.g., one for in-phase and the other for quadrature-phase), for example, as shown in FIG. 5. The oscillator (VCO) signal may be split into two signals, for example, two signals equal in amplitude but with a phase difference (e.g., phase difference of exactly 90°). These two quadrature signals (e.g., I and Q path signal) may drive the inputs of the two mixers (e.g., the two mixers that are viewed as analog multipliers). The outputs of these two mixers (e.g., analog multipliers) may be added together (e.g., in the combiner block of the IQ modulator) to provide the IQ modulator's output. The IQ modulator signal may be expressed as s(t)=I(t) cos 2πf_{c}t−Q(t) sin 2πf_{c}t, where I(t) and Q(t) may be in-phase and quadrature-phase signals, respectively.

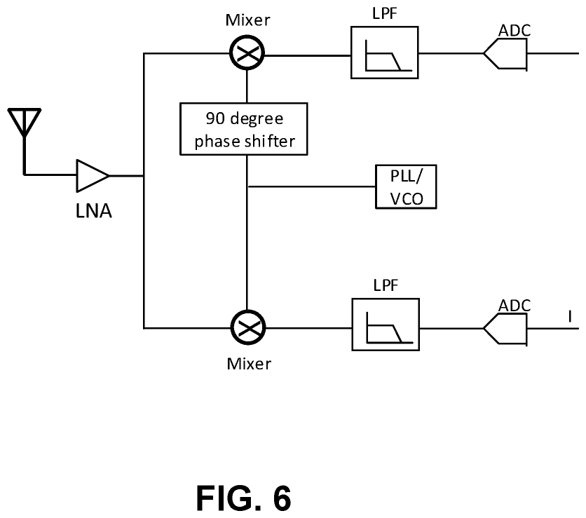

FIG. 6 shows an example of direct conversion/zero-IF architecture. One or more features of a direct conversion and zero-intermediate frequency (IF) architecture may be used in one or more examples as described herein. The direct conversion may include, for example, a direct down-conversion of an RF signal to a baseband (BB) signal or vice versa without intermediate frequency stages (e.g., any intermediate frequency stages), and, in examples, it may be referred to as a zero IF architecture. The direct-conversion receiver may be referred to as a homodyne when the oscillator is phase-locked with the carrier of the received signal. The direct-conversion architecture may have one or more features. For example, as shown in FIG. 6, the direct-conversion receiver may not have intermediate RF (e.g., IF), and the filtering (e.g., all the filtering) may be carried out at baseband and, in examples, analog filtering used in zero-IF architecture may be alleviated.

In some examples, massive MIMO transmitters (e.g., conventional massive MIMO transmitters) may require a large number of end-to-end RF chains to transmit to multiple users using multiple antenna port(s) and/or layers, which may result in a high hardware complexity and/or high power consumption (e.g., this may be unbearable with large MIMO implementations). These transmitters may be employed using three architectures: analogue beamforming, digital beamforming and/or hybrid beamforming. Analog beamforming may be cost-effective, and, in some examples, may suffer from beam squint and/or may be limited by a single beam. Digital beamforming may allow a control of antenna element(s) (e.g., a full control of each antenna element), and, in some examples, may require a single transceiver unit (TXRU) for an (e.g., each) antenna element. Hybrid beamform beamforming architectures, which combine both analogue and digital beamforming, may be capable of generating multiple beams with reduced TXRU, and, in some examples, may inherit the issues of both analogue and digital beamforming schemes.

Some OFDM-based schemes (e.g., conventional OFDM-based schemes) may suffer from high peak-to-average power ratio (PAPR) of the transmitted signal(s), which may introduce a performance degradation as a result of non-linearity in power amplifiers. Techniques, such as clipping, may be used in these OFDM-based schemes and/or may inflict some issues (e.g., one or more of: in-band distortion(s); out-of-band radiation(s); and/or destroying the orthogonality (ies) among subcarriers).

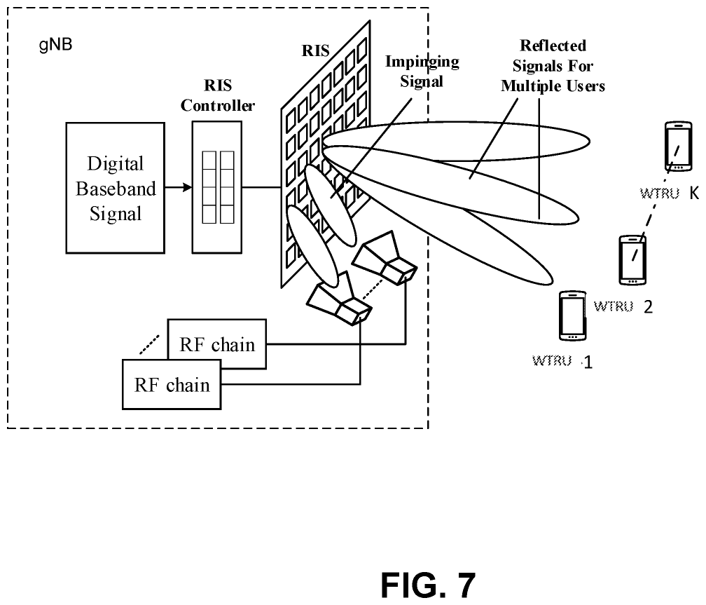

FIG. 7 shows an example of a RIS-based transmitter (e.g., a RIS-based multi-user transmitter). RIS-based modulation may be used in one or more examples as described herein. RIS/RHS transmission(s) may be implemented. As described herein, the transmitter may use either a RIS or an RHS to perform transmission(s). A RIS may include, for example, a passive surface that includes a number (e.g., a large number) of elements (e.g., electronically programmable passive elements). The RIS elements may be controlled using a RIS controller to adjust the characteristics of a signal (e.g., an impinging signal transmitted from an external source). As shown in the example RIS-based transmitter shown in FIG. 7, the transmitter may be equipped with a single RF or multiple RF chains as well as a single antenna or multiple antenna elements (e.g., NT antenna elements shown in FIG. 3). The RF chain(s) may be used to provide a single-tone and unmodulated signal (e.g., to provide the RIS-based transmitter with a single-tone and unmodulated sine wave signal). The transmitter may be equipped with a collocated controller that controls the RIS. In examples, the RIS may be deployed near the transmitter. The antenna(s) may transmit a single-tone signal towards the RIS, where the RIS controller configures the RIS elements to apply one or more of the following to the reflected signals towards multiple users: modulation, beamforming, or precoding (e.g., joint modulation, beamforming and precoding). In examples, a base station (e.g., a gNB) may include one or more (e.g., all) of the following: a baseband unit, the RIS controller, an RIS, or antenna element(s) associated with the RF chain(s).

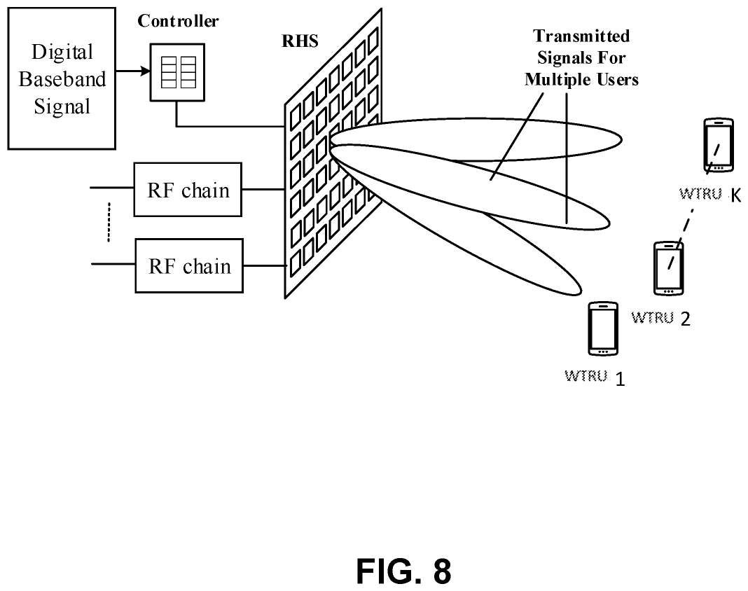

FIG. 8 shows an example of a RHS-based transmitter (e.g., a RHS-based multi-user transmitter). A RHS may include a number of (e.g., a large number of) RHS elements (e.g., electronically programmable active elements). The RHS elements may generate beams and/or be controlled using a RHS controller. As shown in the example RHS-based transmitter shown in FIG. 8, the transmitter may be equipped with a single RF or multiple RF chains that are connected to an RHS. The RF chain(s) s may be used to generate a single-tone and unmodulated signal (e.g., sine wave), where a single-tone signal may be transmitted via the RHS (e.g., the RHS transmits the single-tone signal). The RHS controller may configure the RHS to apply one or more of the following to the reflected signals towards multiple users: modulation, beamforming, or precoding (e.g., joint modulation, beamforming and precoding).

RIS/RHS elements may be configured as described in one or more examples herein. RIS/RHS elements may be used to reflect/transmit a signal x, where the reflection coefficient of the n-th RIS element, denoted as φₙ, may be configured based on the complex value xₙ. For the n-th RIS element, the reflection coefficient φₙ may be controlled by the n-th configurable load impedance

$${Z}_{L}^{( n )}$$

and may be expressed, for example, as Eq. 1.

$${ϕ}_{n} = \frac{{Z}_{L}^{( n )} + {Z}_{0}}{{Z}_{L}^{( n )} + {Z}_{0}} \qquad Eq . 1$$

In Eq. 1, Z₀ is the free space impedance usually set as Z₀=50Ω. The corresponding amplitude βₙ and phase shift θₙ of φₙ may be written, for example, as Eq. 2 and Eq. 3, respectively.

$${β}_{n} = \vert \frac{{Z}_{L}^{( n )} + {Z}_{0}}{{Z}_{L}^{( n )} + {Z}_{0}} \vert \qquad Eq . 2$$

$${θ}_{n} = {tan}^{- 1} ( \frac{{Z}_{L}^{( n )} + {Z}_{0}}{{Z}_{L}^{( n )} + {Z}_{0}} ) \qquad Eq . 3$$

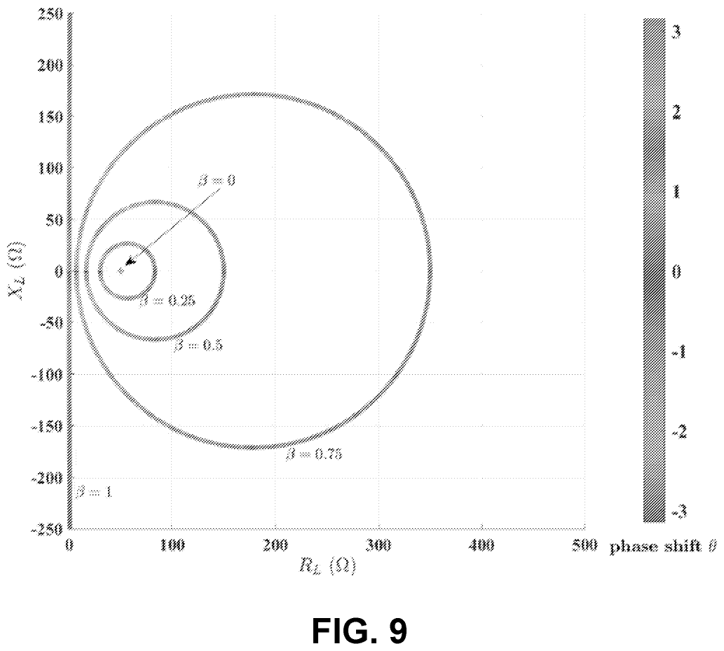

FIG. 9 shows an example of a relationship between a reflection coefficient (e.g., the reflection coefficient φₙ) and a configurable load impedance (e.g., the configurable load impedance

$${Z}_{L}^{( n )} ) ,$$

where Eq. 4 and Eq. 5 may be used to determine φₙ and

$${Z}_{L}^{( n )} ,$$

respectively.

$${ϕ}_{n} = {β}_{n} {e}^{j 2 π {θ}_{n}} \qquad Eq . 4$$

$${Z}_{L}^{( n )} = {R}_{L}^{( n )} + j {X}_{L}^{( n )} \qquad Eq . 5$$

A RIS/RHS-based transmission scheme (e.g., a RIS/RHS-based transmission scheme with joint precoding, beamforming and modulation) may be described herein. The precoding and beamforming may be performed digitally and employed nondigitally (e.g., employed in the analogue domain, and, for example, the precoding or beamforming matrices may be employed in the analogue domain). For example, virtual digital processing may be achieved this way. In examples, for a virtual digital processing, digital and analog processing (e.g., a mix of digital and analog processing) may be used. Multiple example modulations schemes may be presented or used in one or more examples herein (e.g., PSK, APSK and QAM modulations).

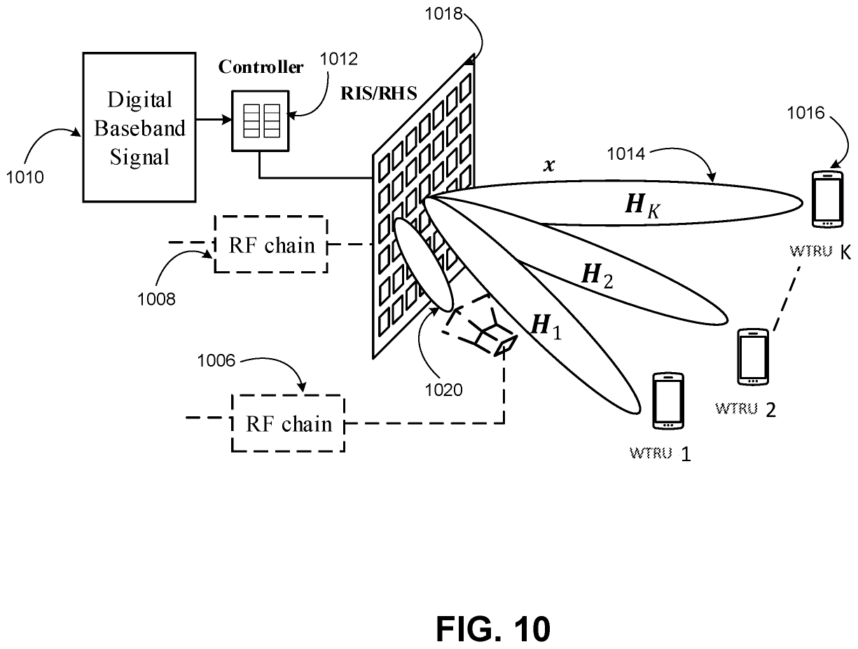

RIS/RHS-based joint precoding, beamforming and modulation may be described in one or more examples herein. A system model may be used in one or more examples as described herein. FIG. 10 shows an example RIS/RHS-based transmission (e.g., an example RIS/RHS-based multi-user transmission). As shown in FIG. 10, a RIS/RHS wireless transmission system (e.g., a basic RIS/RHS wireless transmission system) may be provided. This system may include (e.g., be formed using) one or more of the following parts: a transmitter (Tx) with Nₜ antenna elements (e.g., the transmitter shown in FIG. 7); a RIS/RHS with N elements; a K users (e.g., each with Nᵣ antenna elements). In examples, the transmitter may be equipped with a RIS/RHS controller (e.g., a collocated RIS/RHS controller). The RIS/RHS controller may receive information from a baseband unit and configures (e.g., tunes) the RIS/RHS elements (e.g., phase-shift, amplitude etc.) based on the input information (e.g., information of the modulation, precoding and beamforming). As shown in FIG. 10, a transmitter may be equipped with a RF chain 1006 (e.g., a RF chain associated with a first antenna element of the Nₜ antenna elements) and/or a RF chain 1008 (e.g., a RF chain associated with a second antenna element of the Nₜ antenna elements). The RF chain 1006 (or the RF chain 1008) may be used to provide a single-tone (e.g., single carrier frequency) and unmodulated signal. In examples, the RF chain 1006 may be a reduced RF chain for which an upconversion component may not be required. The RF chain 1008 may be associated with an RHS (e.g., it may be used to generate a single-tone and unmodulated signal for the RHS).

A signal 1020 (e.g., the single-tone and unmodulated signal, for example, as an impinging signal) may be transmitted (e.g., from an antenna element of the Nₜ antenna elements and/or via the RF chain 1006) towards the RIS 1018, for example, as an input signal. The RIS controller 1012 may configure the RIS/RHS elements of the RIS 1018, for example, to apply one or more of the following: modulation, beamforming, or precoding (e.g., joint modulation, beamforming and precoding) to the signal 1020 (e.g., the input signal to the RIS 1018). A signal (e.g., a reflected signal) may be transmitted to a user 1016 (e.g., WTRU K), in association with a channel 1014 represented by Hₖ. A transmitter (e.g., a gNB) may include a baseband unit that generates a baseband signal 1010, which the RIS/RHS controller 1012 may use to configure the RIS elements of the RIS 1018 and may include the RIS/RHS controller 1012. In examples, the transmitter may include the RIS 1018. In some examples, the RIS 1018 may be separated from the transmitter (e.g., the RIS 1018 may be deployed near or far away from the transmitter).

A transmitted signal (e.g., including a transmitted symbol according to Eq. 6) may be used in one or more examples as described herein. A RIS/RHS may be adapted in one or more examples as described herein to perform one or more of the following: modulation, beam forming, or precoding (e.g., joint modulation and/or beamforming/precoding), for example, to support multi-user transmission(s). A transmitted symbol x may include a precoding matrix P (e.g., precoding matrix that enables multi-user transmission(s)), a power allocation matrix ∧, as well as the modulated information s. In examples, the transmitted symbol may be determined using Eq. 6.

$$x = Λ P s . \qquad Eq . 6$$

A channel model may be used in one or more examples as described herein. As shown in FIG. 10, the channel between a transmitter and the k-th user may be represented by (or expressed as) Hₖ. For example, the channel matrix between the transmitter and K users (e.g., all users in the example shown in FIG. 10) may be given by H=[h₁, h₂, . . . , h_{K}]^{H} ∈C^{K×N} (e.g., in case of having a single receive antenna at each user such as Nᵣ=1). Channel fading between the RIS/RHS and the users may be represented in the channel model (e.g., the classic exponential correlation channel model may be adopted to represent the channel fading between the RIS/RHS and the users). For example, it may be assumed that the signals between a RIS and users experience Rayleigh fading (e.g., given the mobility of the users). Channel vector information may be determined based on one or more of the following: a path loss from the RIS/RHS to a user, or a small-scale fading from the RIS/RHS to the user. Channel vector information (e.g., the channel vector

$${h}_{k}^{H} )$$

may be determined using (or given by)

$${h}_{k}^{H} = \sqrt{{υ}_{r , k}} {w}_{k}^{H} ,$$

where ν_{r,k} may be used to denote the path loss from the RIS/RHS to the k-th user. The path loss ν_{r,k} may be determined using (or given by)

$${υ}_{r , k} = {ϱ}_{0} {d}_{r , k}^{- {α}_{r}} ,$$

where ∂₀ may be used to denote the path loss at the reference distance of 1 meter, αᵣ may be used to denote the path loss exponent from the RIS/RHS to the users, and d_{r,k} may be used to denote the distance between the RIS/RHS and the k-th user. In examples,

$${w}_{k}^{H}$$

(e.g., the

$${w}_{k}^{H}$$

used to determine the channel vector information) may be used to denote the small-scale fading from the RIS (e.g., the RIS-based transmitter) to the k-th user, where

$${w}_{k}^{H} ∼ {𝒩}_{𝒞} ( {0}_{N} , R )$$

and R may be used to denote the covariance matrix of the channel vector

$${w}_{k}^{H} .$$

In an exponential correlation channel model, R may be determined based on distance(s) between adjacent RIS elements (e.g., determined by the distance, between adjacent RIS elements d₀). In examples, the (n₁, n₂)-th entry in R may be given by

$${R}_{{n}_{1} , {n}_{2}} = exp ( - \frac{{d}_{{n}_{1} , {n}_{2}}}{{d}_{ref}} ) ,$$

where dₙ_{₁}_{,n}_{₂} may be used to denote the distance between the n₁th and n₂th RIS element, and d_{ref} may be used to denote a constant that controls the level of correlation. The path loss may be denoted as T=diag {ν_{r,1}, ν_{r,2}, . . . , ν_{r,K}}, and the small scale fading from the RIS/RHS to K users (e.g., all K users) may be denoted as W=[w₁, w₂, . . . , w_{K}]^{H}. A channel matrix from the RIS/RHS to K users (e.g., the equivalent channel matrix from the RIS/RHS to all K users) may be determined using (or given by) H=\sqrt{TW}.

One or more transmission components associated with a RIS-based precoding, beamforming and modulation scheme may be used in one or more examples as described herein. The scheme may include transmission components (e.g., precoding, beamforming, and modulation).

Digital-based analog precoding may be used in one or more examples as described herein. A multi-user precoding and modulation scheme (e.g., the multi-user precoding and modulation scheme as described herein) may be based on digital processing and/or weights that may be applied in an analog domain (e.g., the weights may be applied in the analog domain using the RIS/RHS elements). In examples, a controller (e.g., the RIS/RHS controller) may configure the RIS/RHS elements for applying the precoding weights (e.g., the controller may tune the RIS/RHS elements (e.g., with the aid of impedance unit) for applying the precoding weights after determining the weights of a multi-user precoding matrix P and the constellation symbols).

For example, a precoding matrix may be formulated as

$$P = {{H}^{H} ( H {H}^{H} )}^{- 1} = [ {P}_{1}^{T} {P}_{2}^{T} … {P}_{K}^{T} ] ,$$

and/or the (N×1)-element precoded symbol x may be expressed as Eq. 7. The channel matrix H may be used to denote the full channel matrix obtained after CSI estimation (e.g., the extended channel information presented in one or more examples herein, for example, Hi).

$$x = P s \qquad Eq . 7$$

The controller may receive the (N×1)-element precoded symbol x, for example, as an input signal. For example, the (N×1)-element precoded symbol x may be fed to the controller that translates the symbol into amplitude and phase configurations as shown in Eq. 8.

$$x = [ {ϕ}_{1} {ϕ}_{2} … {ϕ}_{N} ] \qquad Eq . 8$$

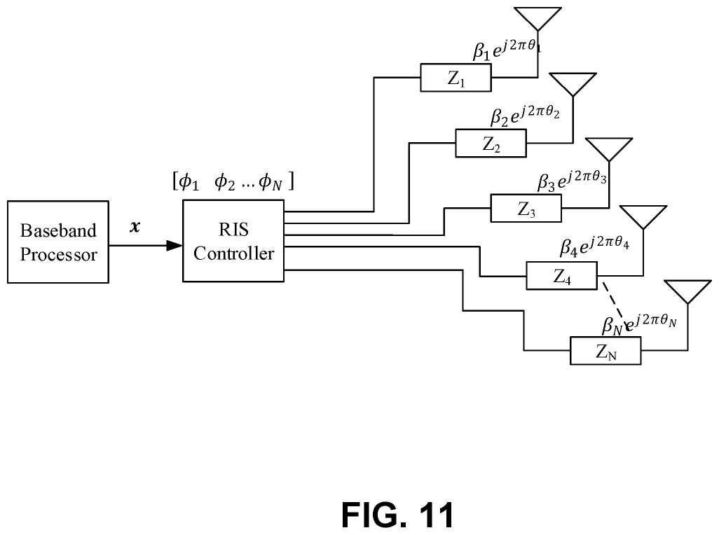

In Eq. 8, the n-th coefficient of x may be determined using (or given by) φₙ=βₙe^{j2πθ}^{ₙ}. A RIS controller may tune the n-th RIS/RHS element using βₙ and θₙ (e.g., amplitude βₙ and phase shift θₙ determined using Eq. 2 and Eq. 3, respectively), as shown in FIG. 11. Information symbol s (e.g., the information symbol shown in Eq. 7) may be based on PSK, APSK, QAM and/or another modulation scheme (e.g., any other modulation scheme), where a transmitter may deal with a modulation scheme differently from another modulation scheme (e.g., each type of modulation may be dealt with differently in the RIS/RHS-based transmitter). FIG. 11 shows an example RIS/RHS controller (e.g., a RIS/RHS controller that tunes the RIS/RHS elements using the phase and amplitude information of x).

One or more of RIS-based joint precoding, beamforming, and PSK/A-PSK modulation may be used in one or more examples as described herein. In examples, a transmitter (e.g., the RIS/RHS-based transmitter) may be configured to transmit modulated information (e.g., PSK/QAM modulated information for K users), where the total number of ports allocated for transmitting the modulated information to the users may be determined (e.g., as discussed in one or more examples herein). Information may be modulated over the phase and/or the amplitude dimensions (e.g., or I/Q) prior to MU-precoding.

A transmitter (e.g., the RIS/RHS-based transmitter) may obtain the precoding weights for K users (e.g., all K users), which may be represented by or expressed as P₁, . . . , P_{K}, for example, after obtaining the symbols for K users (e.g., symbols that may be denoted here as s₁, s₂, . . . , s_{K}). The transmitter may build a precoded symbols x, for example, using Eq. 9. The baseband processor (e.g., the baseband unit used to generate the digital baseband signal 1010) may feed a baseband signal (e.g., the precoded symbol x determined using or given by Eq. 9) to the RIS/RHS controller.

$$x = \sum √ {λ}_{k} {p}_{k} {s}_{k} \qquad Eq . 9$$

In Eq. 9, sₖ may be used to denote the M-ary PSK/QAM information symbol to the k-th user given by

$${s}_{k} = {a}_{v}^{k} {e}^{j \frac{2 π l}{L}}$$

(e.g., or

$${s}_{k} = {e}^{j \frac{2 π l}{L}}$$

in case of PSK modulation), pₖ may be used to denote the precoding vector for the k-th user (e.g., with [symbol] (∥pₖ∥)=1), and λₖ may be used to denote the power allocated to the k-th user of the RIS/RHS. For example, the precoded symbol x may be reflected and/or transmitted from N RIS/RHS elements (e.g., all the N RIS/RHS elements).

The power transmitted from an element (e.g., each element) may be

$$\frac{{E}_{s}}{N} ,$$

and the effective power reflected/transmitted may be

$${β}_{n}^{2} \frac{{E}_{s}}{N} .$$

The total power reflected/transmitted from N elements (e.g., all the N elements), denoted as Eᵣ, may be determined using (or given by) Eq. 10.

$${E}_{r} = {\sum }_{n = 1}^{N} ( {β}_{n}^{2} \frac{{E}_{s}}{N} ) = \frac{{E}_{s}}{N} {\sum }_{n = 1}^{N} {β}_{n}^{2} = {E}_{s} ξ \qquad Eq . 10$$

In Eq. 10,

$$ξ = \frac{1}{N} {\sum }_{n = 1} ( {β}_{n}^{2} )$$

may be used to denote the average power reflectance/transmission of the RIS/RHS elements. Since 0≤βₙ≤1, the power reflectance/transmission may satisfy 0≤ξ≤1, and/or Eq. 11 may be used.

$${λ}_{1} + {λ}_{2} + … + {λ}_{K} = {E}_{r} = {E}_{s} ξ \qquad Eq . 11$$

Eq. 11 may be normalized, as shown in Eq. 12.

$${λ}_{1}^{′} + {λ}_{2}^{′} + … + {λ}_{K}^{′} = 1 \qquad Eq . 12$$

A baseband signal x (e.g., the baseband signal 1010 in FIG. 10) may be determined using (or described as) Eq. 13.

$$x = \sum \sqrt{{E}_{s} ξ {λ}_{k}^{′}} {p}_{k} {s}_{k} \qquad Eq . 13$$

In such a case, the modulated symbols sₖ and the precoding information in pk may be integrated into x (e.g., the baseband signal x determined using EQ. 13), where x may be reflected/transmitted by the RIS/RHS by tuning the N RIS/RHS elements as shown in Eq. 14.

$$x = [ {ϕ}_{1} {ϕ}_{2} … {ϕ}_{N} ] \qquad Eq . 14$$

A modulation and precoding scheme (e.g., any modulation and precoding scheme) may be applied by obtaining precoded symbols (e.g., the precoded symbols as described in one or more examples herein) digitally and then applying them nondigitally to the RIS/RHS elements, for example, as shown in FIG. 11. A modulation (e.g., any modulation) with an amplitude component (e.g., APSK, QAM, etc.) may not incur PAPR, for example, since the amplitude component may be obtained as an amalgam of the RIS/RHS elements power control (e.g., the modulation with an amplitude component may not incur any PAPR, for example, since the amplitude component of the transmitted signal may not be transmitted through a power amplifier but rather by the beamforming gain).

Features associated with single user with QAM modulation may be provided. In examples, a RIS/RHS-based transmitter with N elements may be transmitting QAM-based symbols to a single receiver (e.g., a single receiver with a single antenna element). For example, the transmitted signal may be a single tone signal. The single tone signal (e.g., transmitted from the feeder antenna in case of a RIS or transmitted from the RHS) may be a cosine wave with a center frequency of f_{c}. For example, the transmitted signal may be determined using (or given by) Eq. 15.

$$g = cos ( 2 π {f}_{c} ) \qquad Eq . 15$$

For a given QAM symbol, the RIS/RHS elements may be configured by the controller (e.g., the RIS/RHS controller) to transmit the symbol s=αₗe^{j2πθ}^{ᵢ}. This may be achieved by setting the phase shifts of the elements (e.g., all the elements) to θᵢ and their amplitudes to βₗ as shown in Eq. 16.

$$ϕ = [ {ϕ}_{1} {ϕ}_{2} … {ϕ}_{N} ] = [ {β}_{1} {e}^{j 2 π {θ}_{i}} … {β}_{N} {e}^{j 2 π {θ}_{i}} ] \qquad Eq . 16$$

In Eq. 16, the collective amplitudes may be determined using (or be equivalent to) Σβₙ=Aαₗ, with A being the scaling factor of the N RIS/RHS elements. For example, the reflected/transmitted signal may be determined using (or given by) Eq. 17.

$$x = Real \{ [ {β}_{1} {e}^{j 2 π {θ}_{i}} … {β}_{N} {e}^{j 2 π {θ}_{i}} ] cos ( 2 π {f}_{c} ) \} \qquad Eq . 17$$

The received signal at the user may be determined using (or given by) Eq. 18.

$$y = h x + n \qquad Eq . 18$$

x in Eq. 18 may be determined (or expressed), as shown in Eq. 19 and/or Eq. 20.

$$y = ( A {a}_{l} cos {θ}_{i} cos 2 π {f}_{c} t - A {a}_{l} sin {θ}_{i} sin 2 π {f}_{c} t ) + n \qquad Eq . 19$$

$$x = I cos 2 π {f}_{c} t - Q sin 2 π {f}_{c} t + n \qquad Eq . 20$$

Multi-carrier transmission(s) may be provided. The single user with QAM modulation transmission scheme described herein may be extended to multicarrier transmission(s). In examples, a transmitter (e.g., the transmitter as described in one or more examples herein) may be configured to transmit a CP-OFDM symbol by applying OFDM modulation over N_{fft} subcarriers and/or adding a fixed cyclic prefix (CP). This operation may be performed digitally, e.g., prior to feeding an OFDM precoded symbol (e.g., CP-OFDM) to the RIS/RHS controller.

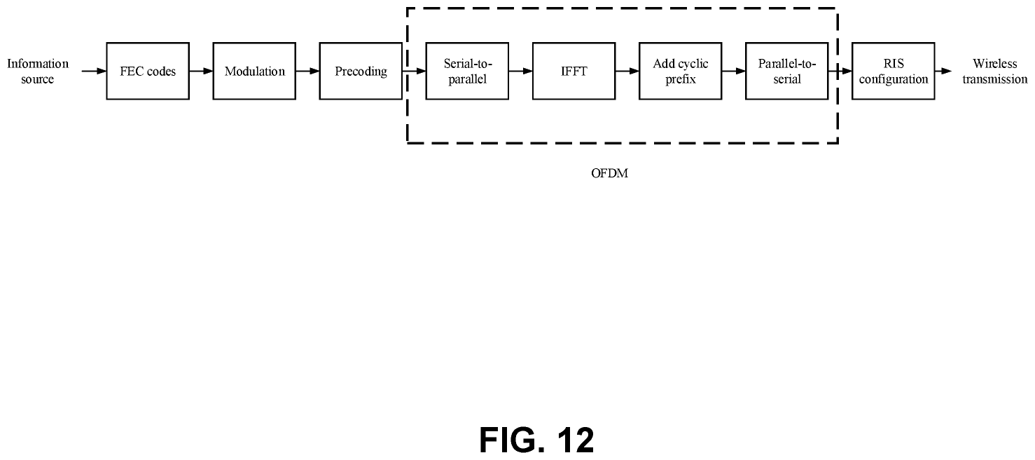

FIG. 12 shows an example block diagram of CP-OFDM. In examples, given a period T=N_{fft}Tₛ, where symbols X₀, X₁, . . . , X_{N}_{_{fft}}₋₁ are transmitted, an OFDM symbol may be determined (or expressed), for example, as shown in Eq. 21.

$$r ( t ) = {\sum }_{{n}_{f f t} = 0}^{{N}_{f f t}} {X}_{{n}_{f f t}} {e}^{\frac{j 2 π k}{T} t} \qquad Eq . 21$$

In Eq. 21,

$$FFT {\{ {x}_{{n}_{f f t}} \}}_{{n}_{f f t} = 0}^{{N}_{f f t}}$$

translates to

$${\{ {X}_{{n}_{f f t}} \}}_{{n}_{f f t} = 0}^{{N}_{f f t}} ,$$

given that Xₙ_{_{fft}}, is the precoded symbol transmitted at the n_{fft}-th subcarrier.

The precoded OFDM symbol r (t) may then be fed into the RIS/RHS controller for n_{fft} (e.g., for each n_{fft}) as control information, for example, as shown in Eq. 22.

$${r}_{{n}_{f f t}} ( t ) = [ {ϕ}_{1} {ϕ}_{2} … {ϕ}_{N} ] \qquad Eq . 22$$

The RIS/RHS may then reflect/transmit the OFDM symbol based on the configuration(s) of the N coefficients

$${\{ {ϕ}_{n} \}}_{n = 1}^{N}$$

(e.g., the configuration of each of the N coefficients

$${\{ {ϕ}_{n} \}}_{n = 1}^{N} ) .$$

In some OFDM schemes (e.g., conventional OFDM schemes), a transmitted signal may suffer from a PAPR issue when it passes through a non-linear power amplifier, which may introduce a performance degradation. In one or more examples as described herein (e.g., in case of using the RIS/RHS-based transmitter), the obtained OFDM signal may not have significant PAPR (e.g., may not experience any PAPR since the large peaks may be transmitted using the collective RIS/RHS elements powers). For example, the RIS/RHS-based signals (e.g., the RIS/RHS-based transmission(s) in one or more examples as described herein) may not suffer from distortion and/or out-of-band radiation (e.g., any distortion and out-of-band radiation).

Power allocations may be performed in one or more examples herein. A RIS/RHS-based power allocation technique may be provided. The power of the reflected/transmitted signal(s) over the RIS/RHS may be divided between users (e.g., to attain the maximum performance in terms of the sum rate, min rate, etc.).

The k-th user may receive the following signal, for example, as shown in a series of equations, represented by Eq. 23.

$${y}_{k} = \sqrt{{υ}_{r , k}} {w}_{k}^{H} x + {n}_{k} \qquad Eq . 23$$

$$= \sqrt{N {υ}_{r , k} {E}_{s} {ξλ}_{k}^{′}} {s}_{l} + {n}_{k} \qquad ( b )$$

In Eq. 23, (a) and (b) may be attained since

$${w}_{k}^{H} {p}_{l} = 0$$

when k≠l and

$${w}_{k}^{H} {p}_{l} = √ N$$

when k=l, respectively.

The received signal to interference plus noise ratio (SINR) of the k-th user may be determined using (or given by) Eq. 24.

$$ρ = \frac{{υ}_{r , k} {E}_{s} {ξλ}_{k}^{′} {‖ {w}_{k}^{H} {p}_{k} ‖}^{2}}{{σ}_{n}^{2} + {υ}_{r , k} {E}_{s} ξ {\sum }_{l \neq k}^{K} {λ}_{l}^{′} {‖ {w}_{k}^{H} {p}_{l} ‖}^{2}} \qquad Eq . 24$$

The achievable rate of the k-th user may be determined (or expressed) as Eq. 25.

$${C}_{k} = {log}_{2} ( 1 + {ρ}_{k} ) = {log}_{2} ( 1 + \frac{N {υ}_{r , k} {E}_{s} {ξλ}_{k}^{′}}{{σ}_{n}^{2}} ) \qquad Eq . 25$$

A power sharing ratio

$${λ}_{1}^{′} + {λ}_{2}^{′} + … + {λ}_{K}^{′}$$

and/or the corresponding power reflectance ξ may be determined under one or more of the following: the constraint of

$${λ}_{1}^{′} + {λ}_{2}^{′} + … + {λ}_{K}^{′} = 1$$

and/or

$${‖ {\sum }_{k = 1}^{K} \sqrt{N ξ {λ}_{k}^{′} ′} \vert {p}_{k} \vert ‖}_{∞} \leq 1 ,$$

for example, using an optimization technique.

In examples, an alternating optimization (AO) technique may be used for calculating (e.g., iteratively calculating) the power sharing ratio and the power reflectance, e.g., while relying on one or more of the techniques as described herein: a maximizing sum-rate method, a maximizing min-rate method, and/or a maximizing geometric-mean-rate technique.

A maximizing sum-rate technique may be described herein. In the maximizing sum-rate technique, maximizing the total spectral efficiency of receivers (e.g., all receivers) may be provided. In this technique, when the average SNR of the users (e.g., all users) is at the low SNR region, the reflecting signals power may be mainly allocated for the receivers with comparably good condition. When the average SNR of the receivers (e.g., all receivers) is at the high SNR region, power is approximately evenly (e.g., evenly) allocated for the users (e.g., all users). Applying the maximizing sum-rate technique may maximize the throughput of the whole system.

Based on the formula of the achievable rate Cₖ, the sum-rate of the K users may be determined using (or given by) Eq. 26.

$${R}_{s u m} = {\sum }_{k = 1}^{K} {C}_{k} = {\sum }_{k = 1}^{K} {log}_{2} ( 1 + \frac{N {υ}_{r , k} {E}_{s} {ξλ}_{k}^{′}}{{σ}_{n}^{2}} ) \qquad Eq . 26$$

The optimization problem of maximizing Rₛᵤₘ may then be formulated, for example, as shown in Eq. 27.

$$\begin{matrix}( P1 . a ) & \\ {max}_{{ξ , {λ}_{1}^{′} , {λ}_{2}^{′} , … , {λ}_{K}^{′}}_{}} {\sum }_{k = 1}^{K} {log}_{2} ( 1 + \frac{N {υ}_{r , k} {E}_{s} {ξλ}_{k}^{′}}{{σ}_{n}^{2}} ) & Eq . 27\end{matrix}$$

$$s . t . {λ}_{1}^{′} + {λ}_{2}^{′} + … {λ}_{K}^{′} = 1 ,$$

$${‖ {\sum }_{k = 1}^{K} \sqrt{N ξ {λ}_{k}^{′}} \vert {p}_{k} \vert ‖}_{∞} < 1$$

First, if the power reflectance ξ is fixed and the second constraint in (P1.a) is ignored, the optimization program (P1.a) may be written, for example, as Eq. 28.

$$\begin{matrix}( P1 . b ) & \\ {max}_{{λ}_{1}^{′} , {λ}_{2}^{′} , … , {λ}_{K}^{′}} {\sum }_{k = 1}^{K} {log}_{2} ( 1 + \frac{N {υ}_{r , k} {E}_{S} {ξλ}_{k}^{′}}{{σ}_{n}^{2}} ) & Eq . 28\end{matrix}$$

$$s . t . {λ}_{1}^{′} + {λ}_{2}^{′} + … {λ}_{K}^{′} = 1$$

The optimization program (P1.b) may then be solved, for example, by the classical water-filling technique.

Second, the power sharing ratio

$${λ}_{1}^{′} , {λ}_{2}^{′} … {λ}_{K}^{′}$$

may be obtained, then the bisection method may be used, e.g., to find the power reflectance ξ that satisfies the second constraint in (P1.a).

The process of the alternating optimization technique for maximizing the sum-rate may be presented in example 1 (e.g., the example Algorithm 1), where ξₘᵢₙ is the lower bound of ξ and the initial ξₘᵢₙ may be set to 0, ξₘₐₓ the upper bound of ξ and the initial ξₘₐₓ may be set to 1. ε_{ξ} may be the maximum tolerate error of ξ, and

$$[ \begin{matrix}{λ}_{1}^{′} & {λ}_{2}^{′} & … & {λ}_{K}^{′}\end{matrix} ] = {f}_{s u m} ( \frac{{E}_{s}}{{σ}_{n}^{2}} , ξ , {υ}_{r , 1} , {υ}_{r , 2} , … , {υ}_{r , K} )$$

may be the function of calculating the power sharing ratio, for example, of each user by using the classic water-filling technique, given

$$\frac{{E}_{s}}{{σ}_{n}^{2}} ,$$

ξ,ν_{r,1}, ν_{r,2}, . . . ν_{r,K}.

A maximizing min-rate technique may be described herein. In the maximizing min-rate technique, the min-rate of the receivers may be maximized. Here, the power may be allocated to ensure that the users (e.g., all the users) have the same received SNR. In some examples, although maximizing the sum-rate may achieve a high throughput (e.g., the highest possible throughput) of the whole system, it may be unfair for the users who have poor channel condition(s). This may be because, for example, most of the power is allocated to the users having good channel conditions. This may leave, for example, a near-zero rate for users having low SNR. The maximizing the min-rate based power sharing technique (e.g., by contrast) may maximize the min-rate of the users (e.g., all users). Based on the formula of the achievable rate Cₖ, the minimum rate of K users (e.g., all K users, denoted as Rₘᵢₙ, may be determined using (or given by) Eq. 29.

$$\begin{matrix}{R}_{min} = min \{ {C}_{1} , {C}_{2} , … , {C}_{K} \} \\ = min \{ {log}_{2} ( 1 + \frac{N {υ}_{r , k} {E}_{s} {ξλ}_{k}^{′}}{{σ}_{n}^{2}} ) ∀ k = 1 , … , K\end{matrix} \qquad Eq . 29$$

The problem of maximizing Rₘᵢₙ may be formulated as, for example, Eq. 30.

$$( P 2. a )$$

$${max}_{ξ , {λ}_{1}^{′} {λ}_{2}^{′} … {λ}_{k}^{′}} min \{ {log}_{2} ( 1 + \frac{N {υ}_{r , k} {E}_{s} {ξλ}_{k}^{′}}{{σ}_{n}^{2}} ) ∀ k = 1 , … , K \} \qquad Eq . 30$$

$$s . t . {λ}_{1}^{′} + {λ}_{2}^{′} + … {λ}_{k}^{′} = 1 ,$$

$${‖ {\sum }_{k = 1}^{K} \sqrt{N {ξλ}_{k}^{′}} \vert {p}_{k} \vert ‖}_{∞} < 1$$

First, the power reflectance ξ may be fixed and the second constraint in (P2.a) may be ignored. Then the optimization program (P2.a) may be written, for example, as Eq. 31.

$$( P 2. b )$$

$${max}_{ξ , {λ}_{1}^{′} {λ}_{2}^{′} … {λ}_{k}^{′}} min \{ {log}_{2} ( 1 + \frac{N {υ}_{r , k} {E}_{s} {ξλ}_{k}^{′}}{{σ}_{n}^{2}} ) ∀ k = 1 , … , K \} \qquad Eq . 31$$

$$s . t . {λ}_{1}^{′} + {λ}_{2}^{′} + … {λ}_{k}^{′} = 1$$

The optimization problem (P2.b) may include or be equivalent to, for example, ensuring that the spectral efficiency of K users (e.g., all K users) is the same. Hence, we arrive at, for example, Eq. 32.

$${υ}_{r , 1} {λ}_{1}^{′} = {υ}_{r , 2} {λ}_{2}^{′} = … {υ}_{r , K} {λ}_{k}^{′} \qquad Eq . 32$$

Since

$${λ}_{1}^{′} + {λ}_{2}^{′} + … + {λ}_{K}^{′} = 1 ,$$

the power sharing ratio of a (e.g., each) user may be determined using (or given by) Eq. 33.

$${λ}_{k}^{′} = \frac{\frac{1}{{υ}_{r , k}}}{\frac{1}{{υ}_{r , 1} + {υ}_{r , 2} + … + {υ}_{r , k}}} , k = 1 , 2 , … , K \qquad Eq . 33$$

Then,

$${λ}_{k}^{′}$$

may be determined (e.g., entirely determined) by ν_{r,1}, ν_{r,2}, . . . , ν_{r,K}.

Second, the power sharing ratio

$${λ}_{1}^{′} \qquad {λ}_{2}^{′} \qquad … \qquad {λ}_{K}^{′}$$

may be fixed e.g., similar to maximizing the sum-rate, the bisection technique may be employed for finding out the maximum of power reflectance ξ satisfying the second constraint in (P2.a). The detailed process of the alternating optimization technique for the maximizing the min-rate may be shown in example 1 (e.g., example Algorithm 1), where

$$[ \begin{matrix}{λ}_{1}^{′} & {λ}_{2}^{′} & … & {λ}_{K}^{′}\end{matrix} ] = {f ( {υ}_{r , 1} , {υ}_{r , 2} , … , {υ}_{r , K} )}_{min}$$

is and example function of calculating a power sharing ratio for a user (e.g., the function of calculating power sharing ratio(s) of each user by maximizing the min-rate, given ν_{r,1}, ν_{r,2} . . . , ν_{r,K}).

A maximizing geometric-rate technique may be provided. The maximizing geometric-rate technique may be a trade-off between the maximizing sum-rate technique and the maximizing min-rate technique. In the low SNR region, the maximizing geometric-rate technique may tend to become similar to (e.g., equivalent to) the maximizing min-rate technique, and power may be mainly allocated to the users with poor channel condition(s) (e.g., to ensure the fairness of the users (e.g., all users)).

Different from the power allocation technique in some MIMO (e.g., conventional MIMO) systems, the power allocation ratios

$${λ}_{1}^{′} , {λ}_{2}^{′} , … , {λ}_{K}^{′}$$

may be designed with a constraint that the amplitude of base band signals is not larger than 1 since the passive characteristic of the RIS elements does not add a (e.g., any) power/amplitude gain (e.g., in the case of using an RHS, the power constraint of 1 may be applied to fix the maximum transmit power at Pₜ=1). In examples, the concept power reflectance ξ may be employed to satisfy this constraint.

A maximizing the geometric-mean-rate technique may be used, for example, since it shows an improved rate-fairness amongst the users. Based on the formula of the achievable rate of the kth user Cₖ, the geometric-mean of the achievable rate of K users (e.g., all K users), denoted as R_{GM}, may be expressed as, for example, Eq. 34.

$${R}_{G M} = {( {\prod }_{k = 1}^{K} {C}_{k} )}^{\frac{1}{K}} = {( {\prod }_{k = 1}^{K} {log}_{2} ( 1 + \frac{N {υ}_{r , k} {E}_{s} {ξλ}_{k}^{′}}{{σ}_{n}^{2}} ) )}^{\frac{1}{K}} \qquad Eq . 34$$

The problem of maximizing R_{GM} may be formulated, for example, as Eq. 35.

$$( P 3. a )$$

$${max}_{ξ , {λ}_{1}^{′} {λ}_{2}^{′} … {λ}_{k}^{′}} {\prod }_{k = 1}^{K} {log}_{2} ( 1 + \frac{N {υ}_{r , k} {E}_{s} {ξλ}_{k}^{′}}{{σ}_{n}^{2}} ) \qquad Eq . 35$$

$$s . t . {λ}_{1}^{′} + {λ}_{2}^{′} + … {λ}_{k}^{′} = 1$$

$${‖ {\sum }_{k = 1}^{K} \sqrt{N {ξλ}_{k}^{′}} \vert {p}_{k} \vert ‖}_{∞} < 1$$

First, the power reflectance ξ may be fixed and the second constraint in (P3.a) may be ignored, then the optimization problem (P3.a) may be written as, for example, Eq. 36.

$$( P 3. b )$$

$${max}_{ξ , {λ}_{1}^{′} {λ}_{2}^{′} … {λ}_{k}^{′}} {\prod }_{k = 1}^{K} {log}_{2} ( 1 + \frac{N {υ}_{r , k} {E}_{s} {ξλ}_{k}^{′}}{{σ}_{n}^{2}} ) \qquad Eq . 36$$

$$s . t . {λ}_{1}^{′} + {λ}_{2}^{′} + … {λ}_{k}^{′} = 1$$

Eq. 36 may be solved, for example, by using the classic Lagrange multiplier technique from the calculus of variations.

Afterwards, an alternating optimization technique (e.g., the classic alternating optimization technique) may be employed to find the optimal power sharing ratio

$${λ}_{1}^{′} \qquad {λ}_{2}^{′} \qquad … \qquad {λ}_{K}^{′}$$

and the corresponding power reflectance ξ for maximizing the geometric-mean-rate.

Example 1 may be an example for an alternating optimization technique for maximizing sum-rate/min-rate/geometric-mean-rate power allocation scheme.

### Example 1 (e.g., Example Algorithm 1)

```
$Input : [ {p}_{1} {p}_{2} … {p}_{k} ] = \sqrt{N} {{W}^{H} ( {WW}^{H} )}^{- 1} , initial {ξ}_{max} , \frac{{E}_{s}}{{σ}_{n}^{2}} , {υ}_{r , 1} , {υ}_{r , 2} , … , {υ}_{k , K} ,$
and ε_{ξ}
  Repeat:
    $ξ = \frac{{ξ}_{min} + {ξ}_{min}}{2}$
    If maximizing the sum-rate power allocation method is employed,
      $[ \begin{matrix}{λ}_{1}^{′} & {λ}_{2}^{′} & … & {λ}_{K}^{′}\end{matrix} ] = {f}_{sum} ( \frac{{E}_{s}}{{σ}_{n}^{2}} , ξ , {υ}_{r , 1} , {υ}_{r , 2} , … , {υ}_{r , K} )$
    elseif maximizing the min-rate power allocation method is employed,
      $[ \begin{matrix}{λ}_{1}^{′} & {λ}_{2}^{′} & … & {λ}_{K}^{′}\end{matrix} ] = {f}_{min} ( {υ}_{r , 1} , {υ}_{r , 2} , … , {υ}_{r , K} )$
    elseif maximizing the geometric-mean-rate power allocation method is employed,
      $[ \begin{matrix}{λ}_{1}^{′} & {λ}_{2}^{′} & … & {λ}_{K}^{′}\end{matrix} ] = {f}_{GM} ( \frac{{E}_{s}}{{σ}_{n}^{2}} , ξ , {υ}_{r , 1} , {υ}_{r , 2} , … , {υ}_{r , K} )$
    end
    $If {‖ {\sum }_{k = 1}^{K} \sqrt{N {ξλ}_{k}^{′}} \vert {p}_{k} \vert ‖}_{∞} < 1 - {ε}_{ξ}$
      ξₘᵢₙ = ξ
    $elseif {‖ {\sum }_{k = 1}^{K} \sqrt{N {ξλ}_{k}^{′}} \vert {p}_{k} \vert ‖}_{∞} > 1$
      ξₘₐₓ = ξ
    end
    $Until 1 - {ε}_{ξ} \leq {‖ {\sum }_{k = 1}^{K} \sqrt{N {ξλ}_{k}^{′}} \vert {p}_{k} \vert ‖}_{∞} \leq 1$
    $Return Power allocation ratio {λ}_{1}^{′} \qquad {λ}_{2}^{′} \qquad … \qquad {λ}_{K}^{′} , and power reflectance ξ$
```

Port allocation(s) may be adaptive. Adaptive port allocation may be performed in one or more examples herein (e.g., using methods and processes associated with adaptive port allocation).

A WTRU may inform a base station (e.g., a gNB) of virtual channel characteristic(s) (e.g., channel characteristics determined using an extended channel matrix as described in one or more examples herein) associated with ports (e.g., virtual antenna ports). A RIS-based transmission may use or rely on a RIS/RHS for transmission as described in one or more examples herein. The base station may dynamically allocate virtual antenna ports that are available through a RIS. In one or more examples herein, the WTRU may inform the base station of the virtual channel characteristics for an array (e.g., full array) of virtual antenna ports (e.g., based on channel measurements), for example, so that the base station may dynamically allocate the virtual antenna ports available through the RIS.

The WTRU may inform the base station of the virtual channel characteristics for a full array of virtual antenna ports (e.g., ports determined using an extended channel matrix as described in one or more examples herein), for example, by sending a virtual CSI report. A virtual CSI report (e.g., a CSI report generated using an extended channel matrix as described in one or more examples herein) may be generated and/or sent, for example, to the base station.

The number of ports may be restricted by the number of radio chains available at the transmitter. An antenna port may be associated with a logical antenna (e.g., it may not refer to a physical port). In examples, the maximum number of ports may be restricted by the number of radio chains available at the transmitter (e.g., 16 to 32). Logical antennas (e.g., associated with virtual antenna ports) may be applicable to RIS-based transmission(s), where the transmission(s) is achieved with the aid of RIS/RHS controller(s). In some examples, the number of transmitted streams may not be related to the number of radio chains. The number of ports may be determined based on the uncorrelated channels between a transmitter and K users (e.g., the number of ports (e.g., virtual antenna ports) may be equivalent to the maximum number of uncorrelated channels between a transmitter and K users), for example, since the number of transmitted streams may not be related to the number of radio chains. For instance, given a K number of users, the total number of antenna ports of a RIS-based transmitter may be equivalent to the total number of uncorrelated channels for the K number of users (e.g., all users)

$$L = {\sum }_{k}^{K} {L}_{k} ,$$

Where Lₖ is the total number
of uncorrelated channels per user (e.g., the number of layers; an uncorrelated channel may be associated with or correspond to a layer). One or more users (e.g., all users) may be assigned in the same resources (e.g., time and frequency resources), where the number of users may change (e.g., K>32), and/or the number of ports (e.g., virtual antenna ports) per user may change. In this way, one or more examples herein may provide for use of a dynamic resource allocation, for example, based on a virtual-CSI report.

The number of uncorrelated channels may be determined based on a channel (e.g., based on channel measurement(s) associated with a RIS/RHS. For example, to determine the number of uncorrelated channels between a WTRU and a base station (e.g., the gNB), the WTRU may determine the channel between a RIS/RHS and the receive antennas (e.g., receive antennas of the WTRU). The WTRU may perform channel measurements on CSI-RS resource(s) (e.g., a CSI-RS resource may map to a RIS element). A CSI-RS resource may or may not be mapped directly to a physical antenna. In some examples, a channel measured at the WTRU may not represent the actual physical channel.

A base station may configure a WTRU with some CSI-RS resources (e.g., CSI-RS ports). A CSI-RS resource may be associated with an RIS element (e.g., a CSI-RS port associated with the RIS element). A WTRU may receive a CSI-RS on the CSI-resource via a RIS (e.g., the RIS element associated with the CSI-RS resource). The WTRU may receive the CSI-RS from a transmitter (e.g., the transmitter in one or more examples as described herein, for example, the transmitter shown in FIG. 10). The transmitter may be associated with the RIS (e.g., the transmitter may include a RIS controller that configures the RIS).

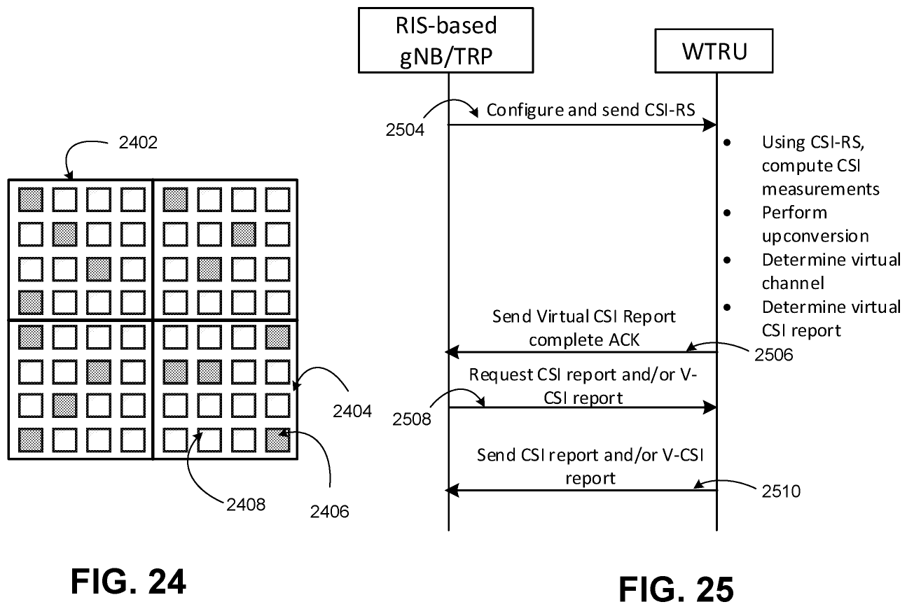

A WTRU may perform measurement(s) based on one or more CSI-RSs (e.g., based on the CSI-RS(s) received via the RIS). The WTRU may not receive a respective CSI-RS for each element of the RIS. The WTRU may receive CSI-RS(s) associated with a first element (e.g., an active element) of the RIS or a first subset of elements of the RIS and may not receive CSI-RS(s) associated with a second element (e.g., an inactive element) of the RIS or a second subset of elements of the RIS. The WTRU may not perform a measurement associated with an element (e.g., an inactive element) of the RIS (or a subset of elements of the RIS) for which CSI-RS(s) associated with the element of the RIS (or the subset of elements of the RIS) has not been received. For example, the measurement(s) performed by the WTRU may be limited to the first element of the RIS (e.g., the active element 2406 shown in FIG. 24) or the first subset of elements of the RIS (e.g., the active elements shown in FIG. 24 including the active element 2406) for which CSI-RS(s) has been received.

The WTRU may determine, for example, based on the measurements, a virtual channel (e.g., the WTRU may estimate a virtual channel using interpolation). The virtual channel may include channel information (e.g., channel vector information) associated with an element (or a subset of elements) for which CSI-RS(s) associated with the element (or the subset of elements) has not been received. For example, the WTRU may estimate, using interpolation, the channel information associated with the element of the RIS (or the subset of elements of the RIS) for which CSI-RS(s) has not been received.

In some examples, the WTRU may perform further measurements on the received CSI-RSs to determine the virtual channel and/or obtain a virtual CSI report. The virtual channel may include (or, in some examples, may be defined as) the channel information after post-processing (e.g., upconversion) of a CSI report that reflects the channel characteristics of an extended part or the whole array of virtual antenna ports.

The WTRU may receive information (e.g., configuration information) associated with the RIS/RHS. The information, for example, may indicate a configuration associated with one or more elements of the RIS. For example, the information (e.g., the information to be exchanged between a RIS/RHS-aided transmitter and a WTRU) may include one or more of the following: the RIS/RHS size (e.g., the number of elements); the number of horizontal RIS/RHS elements and/or vertical RIS/RHS elements; RIS/RHS elements configuration(s) (e.g., phase, amplitude, polarization, etc.). The information, for example, may indicate a configuration associated with the first subset of elements of the RIS and a configuration associated with the second subset of elements of the RIS.

The information associated with the RIS/RHS may include block division information associated with the RIS. The block division information associated with the RIS may indicate that the RIS includes one or more blocks of elements. For example, a base station (e.g., the gNB) may divide a RIS/RHS into blocks and/or sub-blocks (e.g., as shown in FIG. 24) for CSI-RS transmission(s), for example, to determine a RIS/RHS-aided transmitter. FIG. 24 shows an example of dividing a RIS/RHS array into blocks for CSI-RS transmission(s). As shown in FIG. 24, a RIS/RHS array may be divided into 4 blocks (e.g., including block 2402 and block 2404), a block of which includes 16 RIS elements. The base station and/or a transmitter (e.g., a RIS/RHS-based transmitter, for example, a RIS/RHS-aided transmitter) may configure one or more CSI-RS resources based on the blocks (e.g., such that each of the blocks or set of blocks may be dedicated for a CSI-RS port). For example, block 2402 may be associated with a first CSI-RS. Block 2404 may be associated with a second CSI-RS. Block 2402 and block 2404 may be associated with a first CSI-RS or a second CSI-RS. In some examples, an element of a block may be associated with a CSI-RS.

The base station and/or a transmitter (e.g., a RIS/RHS-based transmitter, for example, a RIS/RHS-aided transmitter) may activate one or more elements, e.g., per block, to transmit CSI-RSs. As shown in FIG. 24, the gray squares may be used to denote active elements (e.g., the activated elements) and the white squares may be used to denote inactive elements (e.g., the elements that have not been activated, for example, the deactivated elements). Element 2408 of the block 2404 may be an inactive element, and element 2406 of the block 2404 may be an active element. For example, the element 2408 may not be associated with a CSI-RS, and the element 2406 may be associated with a CSI-RS. The activation of the one or more elements associated with an RIS may be random or follow certain rules/patterns.

The information associated with the RIS/RHS may indicate the activation of elements associated with an RIS/RHS. For example, the information associated with the RIS may indicate that the element 2408 of the block 2402 is an inactive element, and the element 2406 of the block 2404 is an active element.

The information (e.g., about block division and/or elements activation) associated with the RIS/RHS may be signaled, for example, to a WTRU. In examples, the information may be listed in a predefined lookup table, and/or a table index may be signaled to the WTRU (e.g., over DCI or MAC). In some examples, the information associated with the RIS/RHS may be signaled to the WTRU (e.g., MAC-CE)

A WTRU may perform channel estimation to obtain CSI reporting parameters (e.g., one or more of: a channel quality indication (CQI), a precoding matrix indicator (PMI), a rank indicator (RI), or a layer indicator (LI)), for example, after receiving CSI-RS(s) at the WTRU. For example, the WTRU may perform measurement(s) based on the received CSI-RS(s). For example, the measurement(s) performed by the WTRU may be limited to the first element of the RIS (e.g., the active element 2406 shown in FIG. 24) or the first subset of elements of the RIS (e.g., the active elements shown in FIG. 24 including the active element 2406) for which CSI-RS(s) has been received. The WTRU may determine a CSI reporting parameter based on the measurement(s) (e.g., a CSI reporting parameter as opposed to a virtual CSI reporting parameter).

The WTRU may determine a channel matrix, for example, after receiving CSI-RS(s) at the WTRU. The WTRU may determine a first channel matrix based on the measurements that are performed based on the received CSI-RS(s). In examples, the WTRU may determine channel information (e.g., the channel vector information) of one or more active RIS/RHS elements of the RIS/RHS and/or determine the first channel matrix based on the determined channel information of the one or more active RIS/RHS elements. For example, the WTRU may determine a channel matrix Hᵢ, where Hᵢ may be used to denote the channel matrix between N_{α} active RIS/RHS element(s) and WTRU Nᵣ elements (e.g., receiver antenna elements). A virtual CSI report may be determined using the channel matrix Hᵢ, for example, by obtaining, based on the channel matrix Hᵢ, an extended channel matrix H̅ᵢ.

The WTRU may determine a second channel matrix (e.g., an extended channel matrix) based on the first channel matrix that is determined based on channel measurements (e.g., the channel measurements performed using the received CSI-RS(s). For example, the WTRU may use the channel matrix Hᵢ to build an extended channel matrix, which may include the channel information (e.g., the channel vector information) of one or more inactive RIS/RHS elements, for example, by using upconversion technique(s) (e.g., interpolation). Eq. 37 is an example channel matrix Hᵢ that may be used by the WTRU if a single element is activated per block of the RIS/RHS. As shown in Eq. 37, the channel matrix Hᵢ may include multiple channel matrix coefficients

$${h}_{1 , 1}^{i} \qquad … \qquad {h}_{{N}_{a} , {N}_{r}}^{i} .$$

A channel matrix coefficient

$$( e . g . , {h}_{{N}_{a} , {N}_{r}}^{i} )$$

may be associated with an element (e.g., an active element) of the RIS/RHS and/or may indicate channel information (e.g., channel vector information) associated with the element.

$${H}_{i} = [ \begin{matrix}{h}_{1 , 1}^{i} & ⋯ & {h}_{{N}_{a} , 1}^{i} \\ ⋮ & ⋰⋱ & ⋮ \\ {h}_{1 , {N}_{r}}^{i} & ⋯ & {h}_{{N}_{a} , {N}_{r}}^{i}\end{matrix} ] \qquad Eq . 37$$

The determination of the second channel matrix may be further based on the information associated with the RIS/RHS. The configuration information associated with the RIS may indicate a configuration associated with the first subset of elements of the RIS and/or a configuration associated with the second subset of elements of the RIS, for example, as shown in FIG. 24. The WTRU may use the knowledge associated with the RIS (e.g., the knowledge of block division and/or the total number of elements per block) to post-process a channel (e.g., using interpolation), for example, to determine an extended channel matrix H̅ᵢ. The extended channel matrix H̅ᵢ may be used to denote the extended channel matrix between up to Nₜ transmit RIS/RHS elements (e.g., Nₜ may be greater than N_{α}) and Nᵣ elements (e.g., WTRU Nᵣ elements). In examples, the WTRU may use the information (e.g., the information associated with the RIS/RHS) received from a base station (e.g., the gNB) about block division and/or elements activation to map channel matrix Hᵢ to another matrix, \tilde{H}ᵢ, where the locations of inactive elements may be set to zero, as shown in the example Eq. 38.

$${\tilde{H}}_{i} = [ \begin{matrix}{h}_{1 , 1}^{i} & 0 & ⋯ & 0 & {h}_{{N}_{a} , 1}^{i} \\ 0 & {h}_{2 , 1}^{i} & 0 & 0 & 0 \\ ⋮ & {h}_{31}^{i} & ⋰⋱ & 0 & ⋮ \\ {h}_{1 , {N}_{r}}^{i} & 0 & ⋯ & 0 & {h}_{{N}_{a} , {N}_{r}}^{i}\end{matrix} ] \qquad Eq . 38$$

The mapping of zero and non-zero coefficients (e.g., as shown in Eq. 38) may be used (e.g., for interpolation) to determine the extended channel matrix H̅ᵢ. The extended channel matrix may include one or more channel matrix coefficients in addition to channel matrix coefficients

$${h}_{1 , 1}^{i} \qquad … \qquad {h}_{{N}_{a} , {N}_{r}}^{i} .$$

A channel matrix coefficient of the additional channel matrix coefficients may be associated with an element (e.g., an inactive element) of the RIS/RHS. The extended channel matrix (e.g., the post-processed extended channel matrix) H̅ᵢ may be used for the multiple user (MU) transmission(s) in one or more examples herein.

The WTRU may determine a CSI reporting parameter based on the channel information of one or more inactive RIS/RHS elements and/or the channel information of one or more active RIS/RHS elements. For example, using the extended channel information (e.g., the extended channel information associated with the extended channel matrix H̅ᵢ), the WTRU may determine (e.g., compute) one or more virtual CSI reporting parameters (e.g., one or more of: virtual CQI (V-CQI), V-PMI, V-RI, or V-LI), for example, based on a report type (e.g., Type I and Type II as shown in Table 1). The WTRU may send one or more virtual CSI reporting parameters (e.g., CSI reporting parameters determined using an extended matrix as described in one or more examples herein) based on a report type. In examples, a CSI reporting parameter may be determined based on a block of elements (e.g., block 2404 shown in FIG. 24) of the RIS/RHS, and the CSI reporting parameter may be associated with the block of elements (e.g., the CSI reporting parameter may not be associated with other block of elements of the RIS/RHS, for example, block 2402 shown in FIG. 24).

The WTRU may report a CSI report and/or a V-CSI report, for example, as shown in FIG. 25. FIG. 25 shows an example of determining and reporting a CSI report and/or V-CSI report. As shown in FIG. 25, a transmitter (e.g., a RIS-based gNB/TRP) may configure and/or send CSI-RS(s) to a WTRU at 2504. The WTRU may perform one or more of the following: determining CSI measurements using the CSI-RS(s); upconversion; determining virtual channel(s); determining a virtual channel report (e.g., the virtual CSI report as described in one or more examples herein). The WTRU may send to the transmitter a report complete acknowledgement (ACK) (e.g., a virtual CSI report complete ACK) at 2506. The transmitter may send a request for a CSI report and/or V-CSI report to the WTRU at 2508. The WTRU may send the CSI report and/or V-CSI report to the transmitter at 2510.

TABLE 1
Example of CSI reporting and V-CSI reporting contents

| CSI Report content | Virtual CSI Report Content | Type |
|---|---|---|
| CRI, RI, PMI, CQI | V-CRI, V-RI, V-PMI, V-CQI | Type I/II |
| CRI, RI, PMI, CQI, LI | V-CRI, V-RI, V-PMI, V-CQI, V-LI | Type I/II |
| CRI, RI, LI | V-CRI, V-RI, V-LI | Type I |
| CRI, RI, CQI, LI | V-CRI, V-RI, V-CQI, V-LI | Type I |

Port reporting (e.g., port reporting associated with CSI) may be dynamically performed (e.g., as shown by dynamic port reporting in one or more examples herein). In examples, a WTRU may be configured for RIS-based transmission(s), e.g., through RRC or MAC. The configuration may include one or more of the following: the maximum number of CSI-RS and/or demodulation reference signal (DMRS) ports that may be supported; antenna port resources (e.g., in time and frequency domains), where the maximum number of CSI-RS and DMRS ports may be modified. The configuration may include RIS-based transmission configuration. The RIS-based transmission configuration may include antenna port resource(s) (e.g., the time-and-frequency resource for antenna ports including one or more of start symbol(s), frequency domain RE location(s), etc.). The antenna port resource(s) may be based on pre-defined table(s). The antenna port resource(s) may be defined, for example, in RRC message(s). The antenna port resource(s) may be modified, for example, by RRC message(s). In examples, antenna port resource(s) in time and/or frequency domain may be configured and/or signaled based on pre-defined table(s), configured in a RRC message and/or modified by a RRC message.

In examples, the information associated with the RIS/RHS may include configuration information for RIS-based-transmission(s). The configuration information for RIS-based-transmission(s) may include the information about block division and/or elements activation. The configuration information for RIS-based-transmission(s) may indicate one or more of the following: the number of ports that are supported (e.g., the maximum number of CSI-RS antenna ports and/or DM-RS antenna ports that can be supported). In some examples, the number of ports that are supported may be modified. The configuration information for RIS-based-transmission(s) may indicate antenna port resource(s) in time and/or frequency domain (e.g., a start symbol, frequency domain RE locations, etc.). The configuration information for RIS-based-transmission(s) may be sent and/or received via a radio resource control (RRC) message and/or modified via MAC.

Adaptive port allocation may be performed, for example, at RIS-based transmitter(s) (e.g., the RIS-based transmitter(s) as described in one or more examples herein, for example, a RIS-aided transmitter(s)). A base station (e.g., the gNB), for example, after receiving the CSI report and/or V-CSI report associated with K users, may use one or more reports (e.g., a CSI report and/or a V-CSI report) to allocate port(s) (e.g., transmission ports) to a user (e.g., each user), for example, dynamically. In examples, one or more of the following may be performed, for example, by the base station. The base station may include a gNB or transmit/receive point (TRP), for example, a RIS-based gNB or TRP. The base station may request a user to communicate using RIS-based transmission(s). The base station may receive CSI report(s) and/or virtual CSI report(s) from K users. The base station may group one or more of the K users into a transmission group (e.g., a specific MU transmission group G). The base station may determine the number of ports (e.g., the total number of ports) based on the CSI report and/or V-CSI report per user. For example, for some CSI and/or V-CSI reports from a user, the V-RI may be greater than the RI (e.g., the legacy RI, e.g., V-RI>RI), which may allow for allocating more port(s) for this user. The base station may perform a dynamic port allocation per user in a (e.g., each) group. The base station may signal the port resource information, for example, to the user in the group. In examples, the WTRU may receive a request to communicate using RIS-based transmission(s). The WTRU may receive an indication of one or more ports (e.g., transmission ports), for example, after the WTRU sends a CSI reporting parameter to the base station. The CSI reporting parameter may be included in the CSI report and/or the V-CSI report. The WTRU may decode the RIS-based transmission(s) based on the indication of one or more ports.

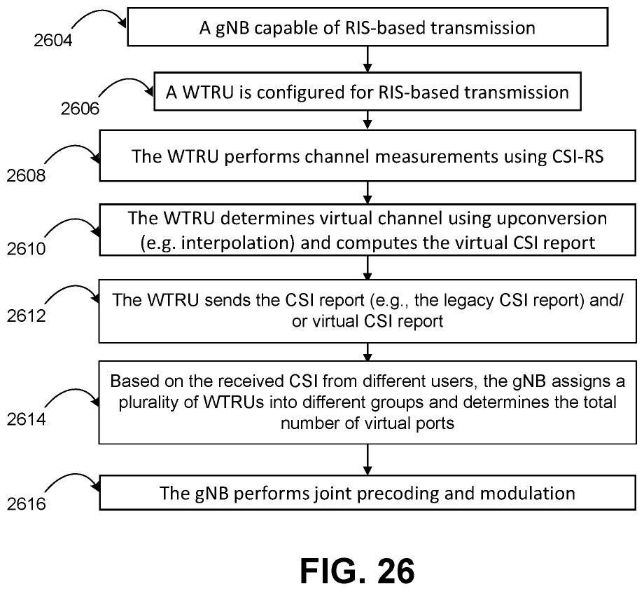

FIG. 26 shows an example for a port allocation associated with RIS-based transmission(s). At 2604, a base station (e.g., a gNB) may determine and/or indicate that the base station is capable of RIS-based transmission(s). At 2606, a WTRU may be configured for the RIS-based transmission(s). For example, the WTRU may receive configuration information for a RIS-based transmission. The configuration information may indicate a CSI-RS associated with an antenna port associated with a RIS. At 2608, the WTRU may perform channel measurements using one or more CSI-RSs (e.g., including a channel measurement using the CSI-RS). At 2610, the WTRU may determine virtual channel(s), for example, using an upconversion (e.g., an interpolation). For example, the WTRU may determine, based on one or more of the channel measurements, virtual channel characteristics associated with a full array of virtual antenna ports. The WTRU may determine (e.g., compute) a virtual CSI report (e.g., a virtual CSI report that indicates the virtual channel characteristics). At 2612, the WTRU may send the CSI report and/or the virtual CSI report. For example, the WTRU may send a first CSI report comprising the virtual channel characteristics (e.g., a number of radio communication layers for the WTRU, PMI, LI etc.) and/or a second CSI report (e.g., a legacy CSI report). At 2614, the base station may assign one or more WTRUs into different groups (e.g., different transmission groups) and/or determine the number of ports (e.g., the total number of virtual ports). At 2616, the base station may perform joint precoding and/or modulation (e.g., as described in one or more examples herein). For example, the base station may determine joint precoding and/or modulation for a WTRU (e.g., each WTRU of a group of WTRUs and/or each WTRU of every group of WTRUs). A controller associated with the RIS (e.g., the RIS (or RHS) controller) may receive precoded modulated symbol(s), for example, from a baseband unit. The controller associated with the RIS may apply the precoded modulated symbol(s) to a RIS element (e.g., each RIS element).

In examples, the base station may perform a port allocation (e.g., a dynamic port allocation) per WTRU in a group. The WTRU may receive an indication of one or more ports (e.g., virtual antenna ports) and/or receive a request to communicate using the RIS-based transmission(s), for example, from the base station. The WTRU may decode the RIS-based transmission(s) based on the request and/or the indication of the one or more ports.

Simulation results are provided. Simulation results may highlight the capabilities of the MU-transmission scheme described herein.

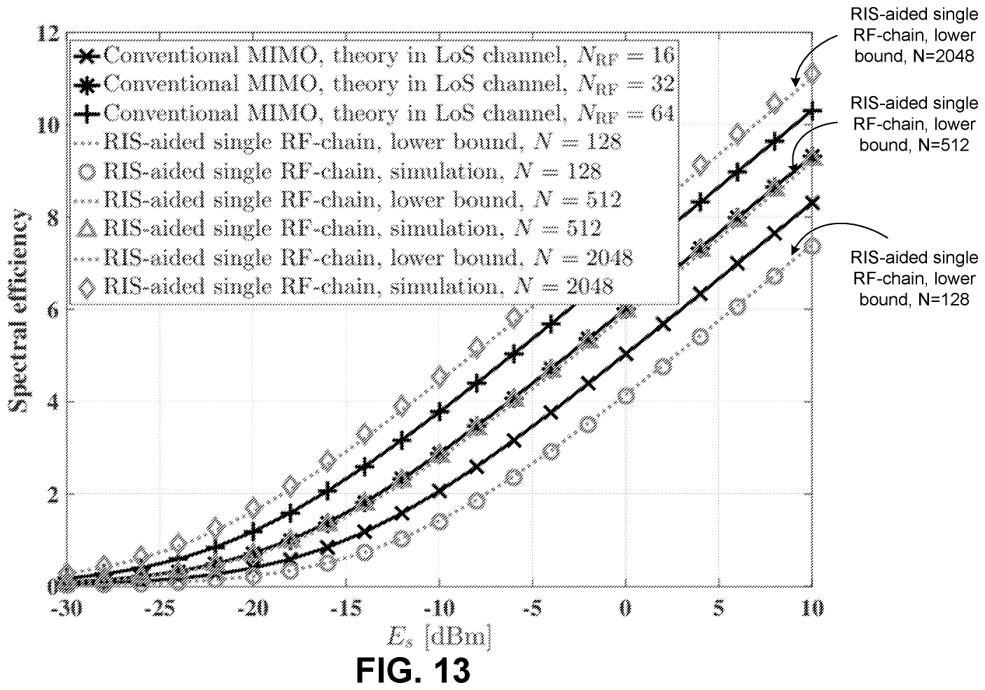

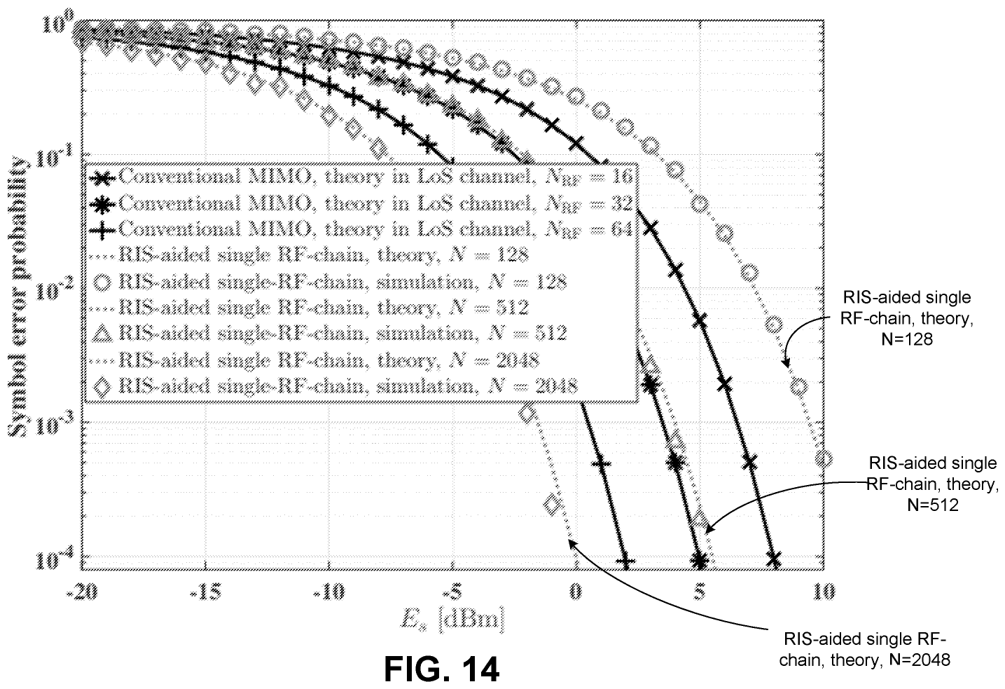

FIG. 13 shows an example of the theoretical and simulation comparison of spectral efficiency versus transmit power for MIMO (e.g., the conventional MIMO) in LoS channels and the RIS-based single-RF downlink information transfer system in Rayleigh channels. FIG. 14 shows an example of the theoretical and simulation comparison of symbol error probability versus transmit power Eₛ for MIMO (e.g., the conventional MIMO) in LoS channels and the RIS-based single-RF downlink information transfer system in Rayleigh channels. As shown in FIGS. 13 and 14, a comparison between the spectral efficiency and symbol error probability of the RIS/RHS-based transmitter and some MIMO schemes (e.g., conventional MIMO schemes) may be provided. Here, the RIS/RHS-based transmission may be associated with a single RF-chain for providing the RIS (e.g., or the RHS) single-tone signal. It may be observed in FIGS. 13 and 14 that the performance of the RIS/RHS-based transmitter scheme improves based on increasing the number of RIS elements. It may be seen that the transmitter attains about 3 dB channel gain when the number of RIS elements doubles. This may be similar to some MIMO systems (e.g., the conventional MIMO systems) where doubling the number of RF-chain brings 3 dB channel gain. When N=2048 RIS elements are deployed, the RIS/RHS-based transmitter may succeed in outperforming some MIMO systems (e.g., conventional MIMO systems) associated with N_{RF}=64 RF chains in LoS channels. In examples, a single RF-chain (e.g., only a single RF-chain) may be required in the RIS/RHS-based transmitter.

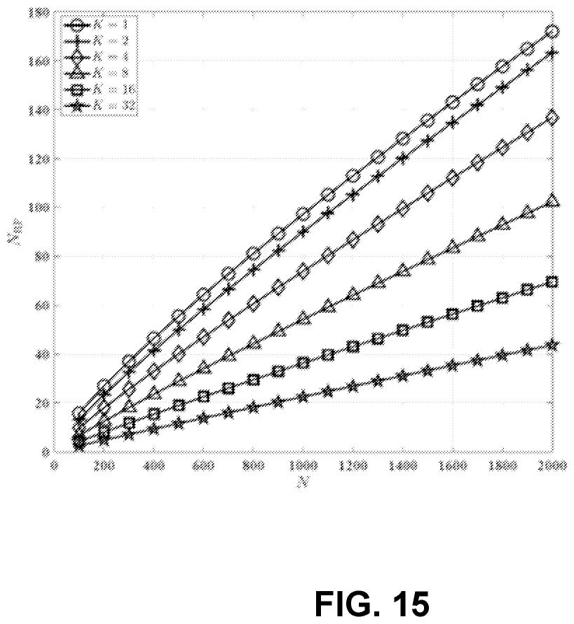

FIG. 15 shows an example of the relationship between the number of RF chains (N_{RF}) in some MIMO systems (e.g., conventional MIMO systems) and the number of RIS elements (N) in the RIS-aided single-RF information transfer scheme when the same ergodic rate is achieved. As shown in FIG. 15, the relationship between the number of RF chains (N_{RF}) in some MIMO systems (e.g., conventional MIMO systems) and the number of RIS elements (N) in the RIS/RHS-based transmitter when the same ergodic rate may be achieved. It may be seen in FIG. 15 that for a given number of users, more RIS/RHS elements may be required with a single RF chain compared to a system (e.g., a conventional MIMO system) with a large number of RF chains. For example, in the case of supporting K=32 users, a RIS/RHS-based transmitter having N=4000 RIS elements may outperform an MIMO system (e.g., a conventional MIMO system) having N_{RF}=40 RF chains.

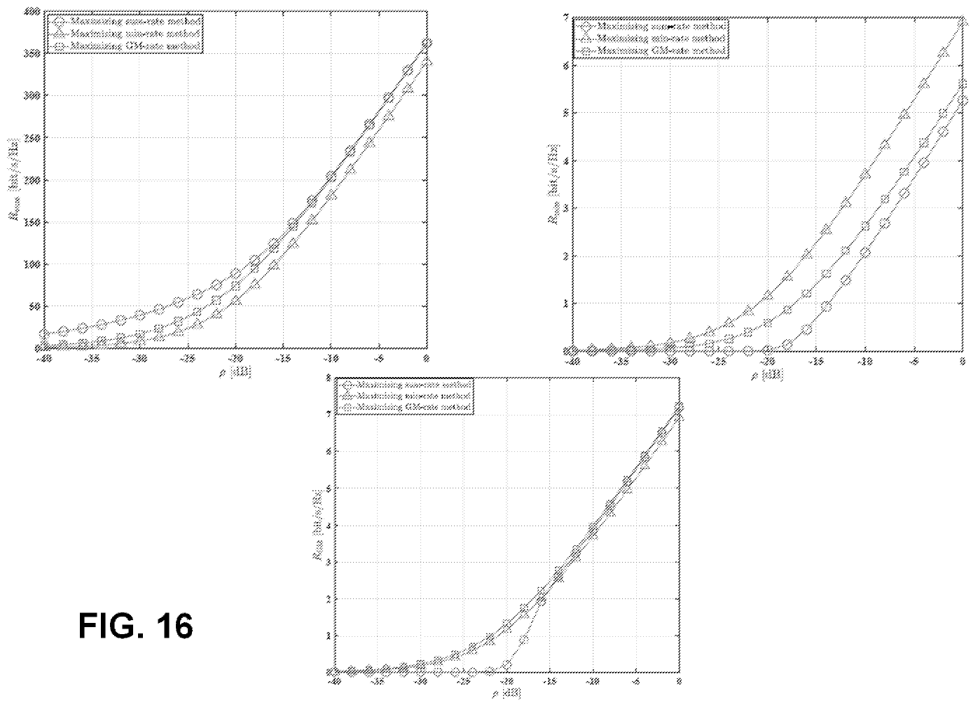

FIG. 16 shows an example of a simulation comparison of sum rate Rₛᵤₘ, minimum rate Rₘᵢₙ, geometric-mean rate R_{GM} versus average receive SINR ρ (e.g., when considering different power allocation techniques). As shown in FIG. 16, the simulation results of the sum rate, denoted as Rₛᵤₘ, the minimum rate, denoted as Rₘᵢₙ, the geometric-mean rate, denoted as R_{GM}, may be compared versus the average receive SINR ρ, when considering the three power allocation techniques. Among these three power allocation techniques, maximizing sum-rate technique may achieve the highest sum rate, while maximizing min-rate technique may achieve the highest minimum rate, and the maximizing geometric-mean-rate technique may achieve the highest geometric-mean rate, which fits the original intention of a (e.g., each) power allocation technique. In the maximizing sum-rate technique, at low receive SINR region, more power may be allocated to the users with good channel conditions, while at high receive SINR region, power may be, for example, approximately evenly allocated to the users (e.g., all users). In the maximizing min-rate technique, more power may be allocated to the users with poor condition. The maximizing geometric-mean rate technique may be a trade-off between the maximizing sum-rate technique and the maximizing min-rate technique. It may show that at the low SINR region, the maximizing geometric-mean-rate technique may tend to become similar to (e.g., equivalent to) the maximizing min-rate technique in which more power is allocated to the users with poor condition, while at the high SINR region, the maximizing geometric-mean-rate technique tends to the maximizing sum-rate technique in which power is evenly allocated to the users (e.g., all users).

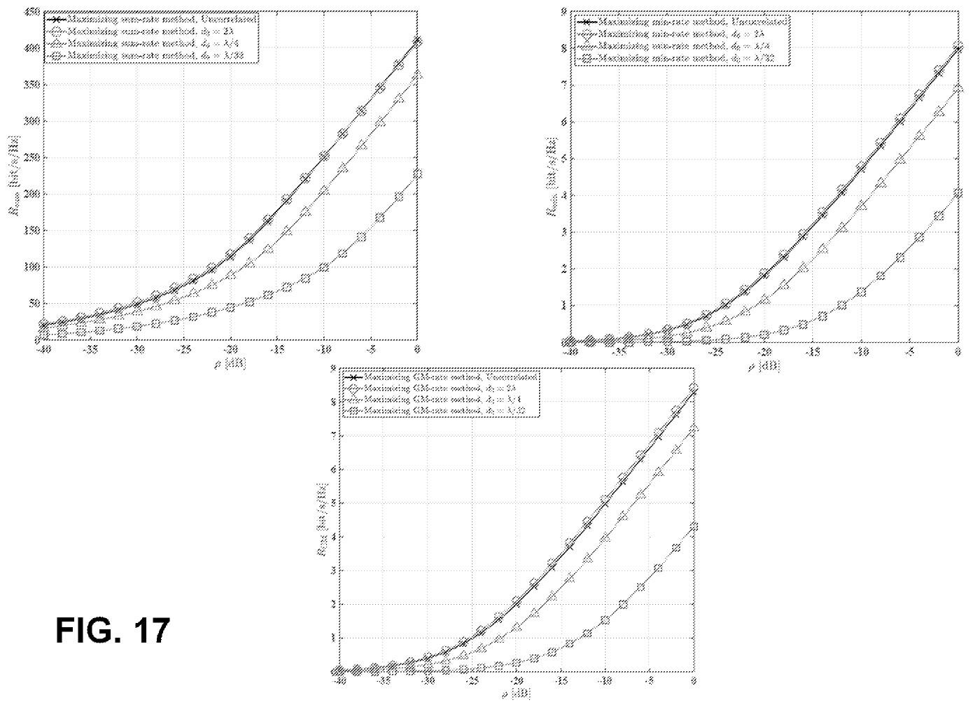

FIG. 17 shows an example of a simulation comparison of sum rate Rₛᵤₘ, minimum rate Rₘᵢₙ, geometric-mean rate R_{GM} versus average receive SINR ρ, for different channel correlation values (e.g., where the maximizing sum-rate technique is employed for the calculation of sum rate, the maximizing min-rate technique is employed for the calculation of minimum rate, and the maximizing geometric-mean-rate technique is employed for the calculation of geometric-mean rate). As shown in FIG. 17, the sum rate Rₛᵤₘ, minimum rate Rₘᵢₙ and geometric-mean rate R_{GM} may be compared versus average receive SINR ρ for different channel correlation values, where the maximizing sum-rate technique is employed for the calculation of sum rate, maximizing min-rate technique is employed for the calculation of minimum rate, and the maximizing geometric-mean-rate technique is employed for the calculation of geometric-mean rate. It may show that when the distance between adjacent RIS elements d₀=2λ, the channel fading between RIS elements is approximately uncorrelated. The system performance degrades upon decreasing the distance between adjacent RIS elements, as shown in FIG. 17.

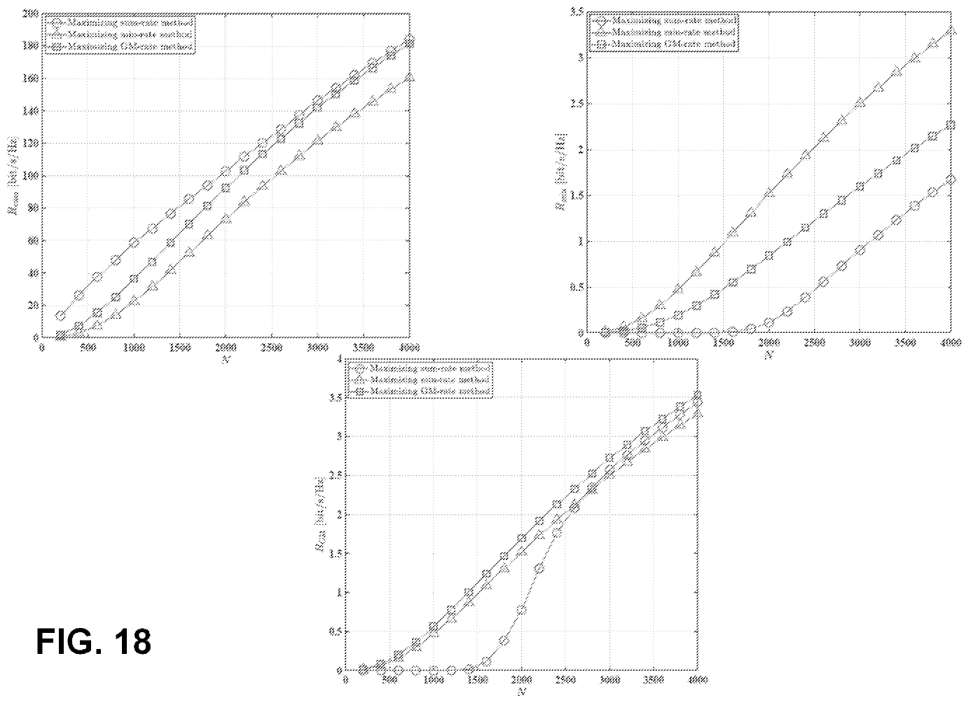

FIG. 18 shows an example of a simulation comparison of sum rate Rₛᵤₘ, minimum rate Rₘᵢₙ, geometric-mean rate R_{GM} versus the number of RIS elements N for different power allocation techniques (e.g., where the average receive SINR ρ=−25 dB). As shown in FIG. 18, the sum rate, minimum rate and geometric-mean rate may be compared versus the number of RIS elements N for the different power allocation techniques, where the average receive SINR ρ=−25 dB. As shown in FIG. 18, in terms of the sum rate and geometric mean rate, the maximizing geometric-mean-rate technique may tend to become similar to (e.g., equivalent to) the maximizing min-rate technique when the number of RIS elements N is small and may tend to the maximizing sum-rate technique when the number of RIS elements N is large. In terms of the min-rate Rₘᵢₙ, the maximizing min-rate technique may achieve the best performance, while the maximizing sum-rate technique may produce the worst performance.

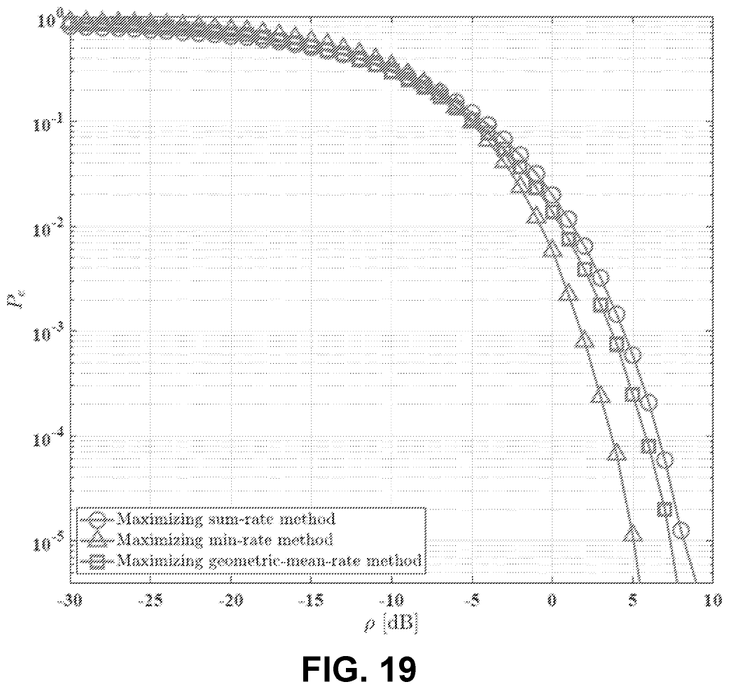

FIG. 19 shows an example of a simulation comparison of symbol error probability Pₑ Versus average receive SINR ρ of various power allocation techniques (e.g., the three power allocation techniques as described in one or more examples herein). As shown in FIG. 19, the symbol error probability Pₑ may be compared versus average receive SINR ρ for the three power allocation techniques, where it is shown that in the low SINR region (e.g., ρ<−10 dB), the SEP performance (e.g., the symbol error probability performance) of the maximizing sum-rate method is slightly better than other two methods. Because in this low SINR region, some or all the users may have poor SEP performance, where in the maximizing sum-rate technique, more power is allocated to the users with comparatively good condition to ensure these users may recover information with relatively good condition. However, in the high SINR region (e.g., ρ>0 dB), the SEP performance of the maximizing min-rate technique may be best while that of the maximizing sum-rate technique may be worst. It may be illustrated that in the high SINR region, the users (e.g., all the users) have good condition overall and the SEP performance may be mainly determined by the users with comparatively poor condition. The maximizing min-rate technique may allocate more power to the users with poor condition, while the maximizing sum-rate technique may approximately evenly allocate power to one or more (e.g., all) users.

Multi-user transmission(s) with OFDM may be disclosed herein. RIS/RHS-aided transmission(s) with OFDM may be disclosed herein.

As an example, for an OFDM symbol with L number of subcarriers and a cyclic prefix of length L_{cp}, the modulated information sₗ in the lth sub-carrier and the precoding matrix Pₗ in the lth sub-carrier may be denoted as sₗ ∈ [symbol] and Pₗ ∈C^{N×K}, respectively. N may represent the number of RIS elements, and K may represent the number of users. The signal transmitted at a RIS element in the frequency-domain, denoted as x̅ₗ ∈ [symbol] , may be determined, for example, using Eq. 39.

$${\overline{x}}_{l} = \sqrt{{E}_{s}} \sqrt{{Λ}_{l}} {P}_{l} {s}_{l} , , l = 1 , 2 , ⋯ , L , \qquad Eq . 39$$

where ∧ₗ=diag {λ_{l,1}, λ_{l,2}, . . . , λ_{l,K}} is the power allocation matrix. λₖ represents the power ratio allocated to the kth user, and it satisfies a condition, e.g., λ₁+λ₂+. . . +λ_{K}=1, and Es denotes the transmitted power in the case of active RIS or RHS, or the impinging signal power in case of a passive RIS. The signal transmitted at the RIS element in the time-domain, denoted as xₗ ∈ [symbol] , may be determined, for example, using Eq. 40.

$${x}_{l} = \sqrt{{E}_{s}} \sqrt{Λ} {F}_{L}^{′} ( l , : ) {\overline{x}}_{l} = \sqrt{{E}_{s}} \sqrt{Λ} {F}_{L}^{′} ( l , : ) {P}_{l} {s}_{l} , l = 1 , 2 , … , L , \qquad Eq . 40$$

where

$${F}_{L}^{′}$$

represents an L×L inverse DFT matrix. Cyclic prefix length may be added to the formula above to determine the signal transmitted at the RIS element in the time-domain. For example, by adding the cyclic prefix with L_{cp} symbols, Eq. 41 may be obtained.

$$\ddot{x} = [ \begin{matrix}{x}_{l} ( L - {L}_{cp} + 1 ) \\ {x}_{l} ( L - {L}_{cp} + 2 ) \\ ⋮ \\ {x}_{l} ( L ) \\ {x}_{l} ( 1 ) \\ {x}_{l} ( 2 ) \\ ⋮ \\ {x}_{l} ( L )\end{matrix} ] , l = 1 , 2 , ⋯ , L \qquad Eq . 41$$

The received signal in the lₜₕ sub-carrier at the kth user (e.g., in time domain), denoted as y_{l,k}, may be determined, for example, using Eq. 42.

$${y}_{l , k} = {h}_{l , k} * {\ddot{x}}_{l} + {v}_{l , k} = {\sum }_{i = 0}^{{τ}_{k}} {h}_{l , k}^{( i )} {\ddot{x}}_{l} ( {L}_{c p} + l - i ) + {v}_{l , k} , \qquad Eq . 42$$

where

$${v}_{l , k} ∼ 𝒞𝒩 ( 0 , {σ}_{v}^{2} )$$

is the additive noise, with

$${σ}_{v}^{2}$$

being the noise power, and the time-domain channel from the RIS to the kth user is denoted as

$${h}_{k}^{( i )} ∈ {C}^{𝕝 \times N} ,$$

and its time-domain delay taps are denoted as

$${h}_{k}^{( 1 )} , {h}_{k}^{( 2 )} , ⋯ , {h}_{k}^{( τ )} k ∈ {C}^{𝕝 \times N} ,$$

respectively, and τₖ stands for delay taps. The frequency-domain of the channel from the RIS to the kth user in the lth sub-carrier, denoted as h̅_{l,k} ∈ [symbol] , may be determined for example, using Eq. 43.

$${\overline{h}}_{l , k} = {F}_{L} ( l , : ) [ \begin{matrix}{h}_{k}^{( 0 )} \\ {h}_{k}^{( 1 )} \\ ⋮ \\ {h}_{k}^{( {τ}_{k} )} \\ {O}_{( L - {τ}_{k} - 1 ) \times N}\end{matrix} ] , \qquad Eq . 43$$

where F_{L} represents a L×L discrete Fourier transform (DFT), and the full matrix is expressed as

$${\overline{H}}_{l} = {[ {h}_{l , 1}^{⊤} , {h}_{l , 2}^{⊤} … , {h}_{l , K}^{⊤} ]}^{⊤} ,$$

and O_{(L-τ}_{ₖ}_{-1)×}N is a zero matrix. The received symbol and the noise at the l-th subcarrier in the time-domain may be denoted as yₗ=[y_{l,1}, y_{l,2}, . . . , y_{l,K}]^{T}, and νₗ=[ν_{l,1}, ν_{l,2}, . . . , ν_{l,K}]^{T}, respectively.

The received signal of the kth user in the lth sub-carrier (e.g., in frequency-domain), y̅_{l,k}, may be determined, for example, using one or more of a series of equations, as shown in Eq. 44.

$${\overline{y}}_{l , k} = {F}_{L} ( l , : ) [ \begin{matrix}{\sum }_{i = 0}^{{τ}_{k}} {h}_{l , k}^{( i )} {\ddot{x}}_{1} ( {L}_{cp} + 1 - i ) + {v}_{1 , k} \\ {\sum }_{i = 0}^{{τ}_{k}} {h}_{2 , k}^{( i )} {\ddot{x}}_{2} ( {L}_{cp} + 2 - i ) + {v}_{2 , k} \\ ⋮ \\ {\sum }_{i = 0}^{{τ}_{k}} {h}_{L , k}^{( i )} {\ddot{x}}_{L} ( {L}_{cp} + L - i ) + {v}_{L , k}\end{matrix} ] , \qquad Eq . 44$$

$${\overline{y}}_{l , k} = {\overline{h}}_{l , k} {\overline{x}}_{l} + {F}_{L} ( l , : ) [ \begin{matrix}{v}_{1 , k} \\ {v}_{2 , k} \\ ⋮ \\ {v}_{L , k}\end{matrix} ] ,$$

$${\overline{y}}_{l , k} = \sqrt{{E}_{s}} \sqrt{Λ} {\overline{h}}_{l , k} {P}_{l} {s}_{l} + {\overline{v}}_{l , k} ,$$

where ν̅_{l,k} represents the frequency-domain additive noise at the kth user in the lth sub-carrier, following

$${\overline{v}}_{l , k} ∼ 𝒞𝒩 ( 0 , {σ}_{v}^{2} ) .$$

In the frequency-domain, a channel model in a (e.g., each) sub-carrier may be determined, for example, using Eq. 45.

$$\begin{matrix}{\overline{y}}_{l} = \sqrt{{E}_{s}} \sqrt{Λ {H}_{l}} {P}_{l} {s}_{l} + {\overline{v}}_{l} , & l = 1 , 2 , … , L\end{matrix} \qquad Eq . 45$$

Precoding with OFDM may be disclosed herein. Precoding may be employed to a sub-carrier (each sub-carrier) prior to transmission in one or more examples herein. As an example precoding, the zero-forcing precoding method may be employed, while other precoding schemes may also be applicable. The ZF precoding matrix in the lth sub-carrier may be determined, for example, using Eq. 46.

$${P}_{l} = ξ [ {p}_{l , 1} , {p}_{l , 1} , … , {p}_{l , 1} ] = ξ \sqrt{N} {{H}_{l}^{H} ( {H}_{l} {H}_{l}^{H} )}^{- 1} , \qquad Eq . 46$$

where p_{l,k} is the kth column of

$$\sqrt{N} {{H}_{l}^{H} ( {H}_{l} {H}_{l}^{H} )}^{- 1} ,$$

and the constant parameter ξ may be employed, for example, for ensuring that the passive beamforming satisfy a condition, e.g., 0≤β_{l,n}≤1. The reflection coefficient Φₗ in the lth sub-carrier may be determined, for example, using Eq. 47.

$${Φ}_{l} = ξ \sqrt{N} {\sum }_{k = 1}^{K} \sqrt{{λ}_{l , k}} {p}_{l , k} {s}_{l , k} , \qquad Eq . 47$$

where s_{l,k} is the M-ary PSK information symbol or M-ary QAM information symbol for the kth user in the lth sub-carrier (e.g., S_{l,k} ∈S_{M-PSK} or S_{l,k} ∈S_{M-QAM}). Eq. 48 may be applicable, for example, given that the amplitude of each RIS passive element is not large than 1 (e.g., 0≤β_{l,n}≤1):

$$max \{ {‖ ξ \sqrt{N} {\sum }_{k = 1}^{K} \sqrt{{λ}_{l , k}} {p}_{l , k} {s}_{l , k} ‖}_{∞} \} \leq 1 , ∀ {s}_{l , k} ∈ {S}_{M - PSK} or {s}_{l , k} ∈ {S}_{M - QAM} , \qquad Eq . 48$$

where ∥·∥_{∞} is the infinity norm of the corresponding vector. In some instances (e.g., shown in the above equation), calculating the amplitude of the transmitted signal in reflection coefficient Φₗ for some or all possible information symbol vector sₗ, may have high computational complexity, for example, when the number of users K and the modulation order M increases. When S_{l,k} ∈S_{M-PSK}, since the PSK-modulated signal s_{l,k} has a constant envelope, for example, according to Cauchy-Schwarz inequality, the following constraint may be used (e.g., take as true), as shown in Eq. 49.

$$max \{ {‖ ξ \sqrt{N} {\sum }_{k = 1}^{K} \sqrt{{λ}_{l , k}} {p}_{l , k} {s}_{l , k} ‖}_{∞} \} \leq ξ \sqrt{N} {‖ {\sum }_{k = 1}^{K} \sqrt{{λ}_{l , k}} {p}_{l , k} {s}_{l , k} ‖}_{∞} , \qquad Eq . 49$$

where the equality is established when the modulation order M→∞. When the modulation order M→∞ (e.g., the equality is established), the constraint may be simplified to, for example, Eq. 50.

$$ξ \sqrt{N} {‖ {\sum }_{k = 1}^{K} \sqrt{{λ}_{l , k}} \vert {p}_{l , k} \vert ‖}_{∞} \leq 1 \qquad Eq . 50$$

For an amplitude-based modulation, such as a QAM modulation (e.g., s_{l,k} ∈S_{M-QAM}), the M-QAM modulation symbols may be normalized, for example, by the largest amplitude in the M-QAM constellation (e.g., given that the amplitude of each RIS passive element is not larger than 1). Limiting the power per element to 1 may be skipped for an active RIS or RHS element. The constraint (e.g., of ≤1) in the above equation may be further simplified to, for example, Eq. 51.

$$ξ \sqrt{N} {‖ {\sum }_{k = 1}^{K} \sqrt{{λ}_{l , k}} \vert {p}_{l , k} \vert ‖}_{∞} \leq \frac{1}{\sqrt{2} ( \sqrt{M} - 1 )} \qquad Eq . 51$$

For M-PSK modulation, the ξ may satisfy, for example, Eq. 52.

$$ξ \leq \frac{1}{\sqrt{N} {‖ {\sum }_{k = 1}^{K} \sqrt{{λ}_{l , k}} \vert {p}_{l , k} \vert ‖}_{∞}} \qquad Eq . 52$$

For the M-QAM modulation, ξ may satisfy, for example, Eq. 53.

$$ξ \leq \frac{1}{\sqrt{2} ( \sqrt{M} - 1 ) \sqrt{N} {‖ {\sum }_{k = 1}^{K} \sqrt{{λ}_{l , k}} \vert {p}_{l , k} \vert ‖}_{∞}} \qquad Eq . 53$$

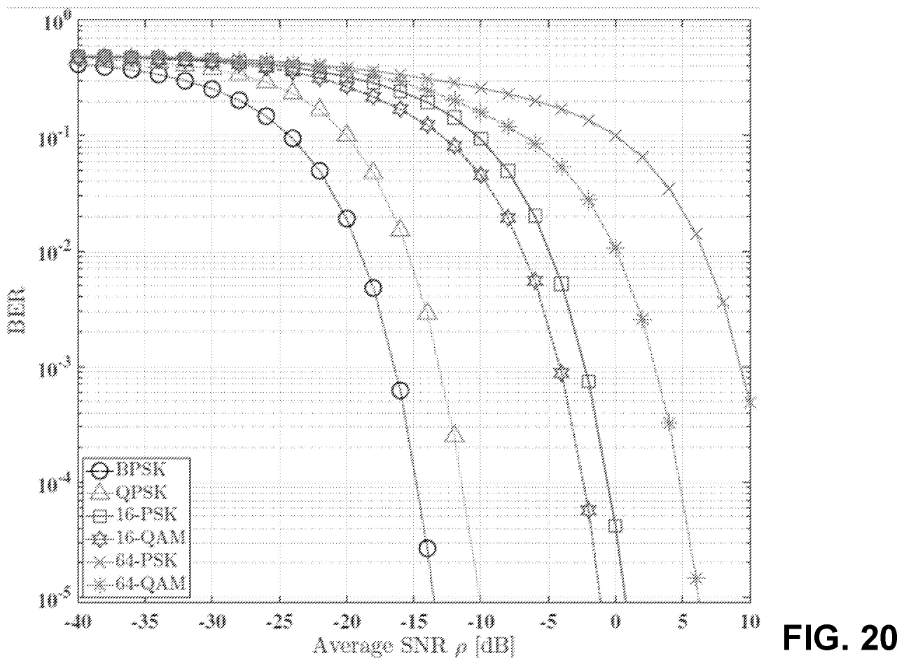

OFDM transmission(s) may incorporate one or more examples herein. Simulation results with OFDM transmission(s) may be disclosed herein (e.g., OFDM having L=64 sub-carriers and a cyclic prefix of length L_cp=16, as shown in FIGS. 20-23). In the examples shown in FIGS. 20-23, the channel from the RIS to the k-th user is associated with delay taps τ₁=τ₂= . . . =τ_{K}=8, and the number of sub-carrier is N_{fft}=L=64, the number of symbols in each cyclic prefix is L_{cp}=16, and the power allocation is

$${λ}_{l , 1} = {λ}_{l , 2} = … = {λ}_{l , k} = \frac{1}{K}$$

for l=1,2, . . . , L.

FIG. 20 shows an example of comparison of BER performance versus average received SNR p with different modulation schemes (e.g., where the number of users K=4 and the number of RIS elements N=256). The example in FIG. 20 shows that the QAM scheme outperforms the PSK scheme under the same modulation order. The example in FIG. 20 shows that, with the increase of the modulation order, the BER performance becomes worse due to the more bits of information transmitted.

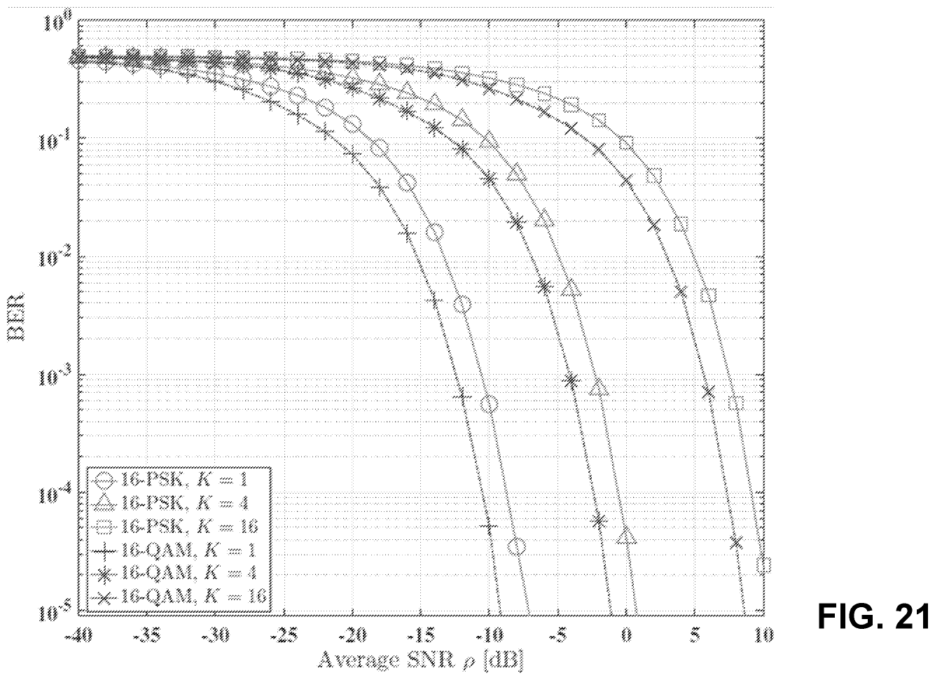

FIG. 21 shows an example of comparison of BER performance versus average received SNR p with different numbers of users K (e.g., where the number of RIS elements is N=256 and the modulation schemes are 16-PSK and 16-QAM, respectively). The example in FIG. 21 shows that higher received SNR may be required when the number of users increases, for example, to ensure the same BER performance requirement. Power impinging on the RIS may be split to support multiple users.

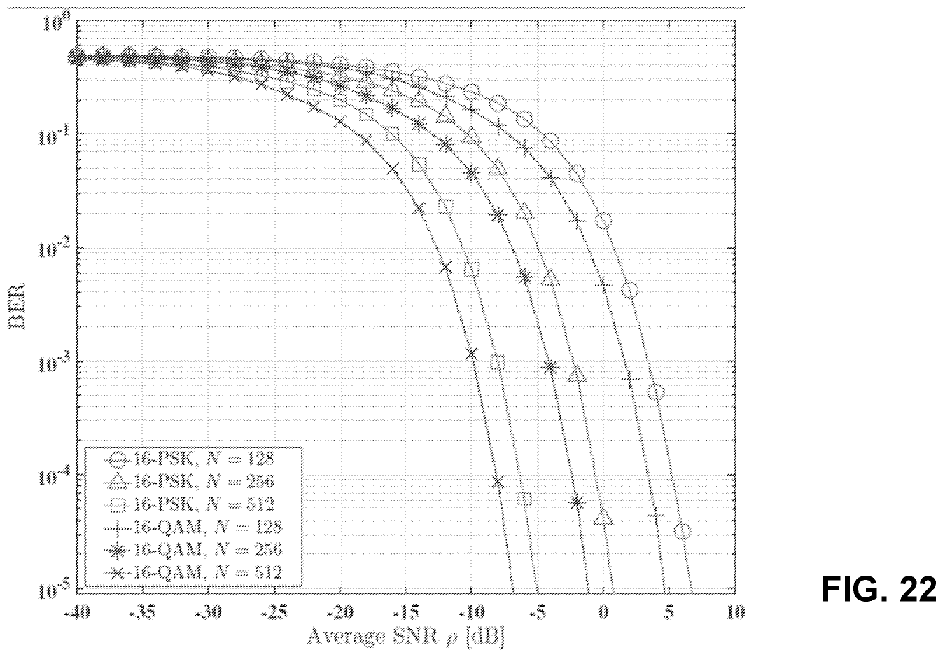

FIG. 22 shows an example of comparison of BER performance versus average received SNR p with different numbers of RIS elements N (e.g., where the number of users is K=4 and the modulation schemes are 16-PSK and 16-QAM, respectively). The example in FIG. 22 shows that doubling the number RIS elements may achieve approximately 6 dB SNR gain. For example, to get the BER performance of 10⁻⁵, the received SNR of −1 dB and 1 dB may be required for the 16-PSK and 16-QAM scheme respectively when the number of RIS elements is N=256. The received SNR of −7 dB and −5 dB may be required for the 16-PSK and 16-QAM scheme respectively when the number of RIS elements increases to N=512, for example, to satisfy the same BER performance requirement.

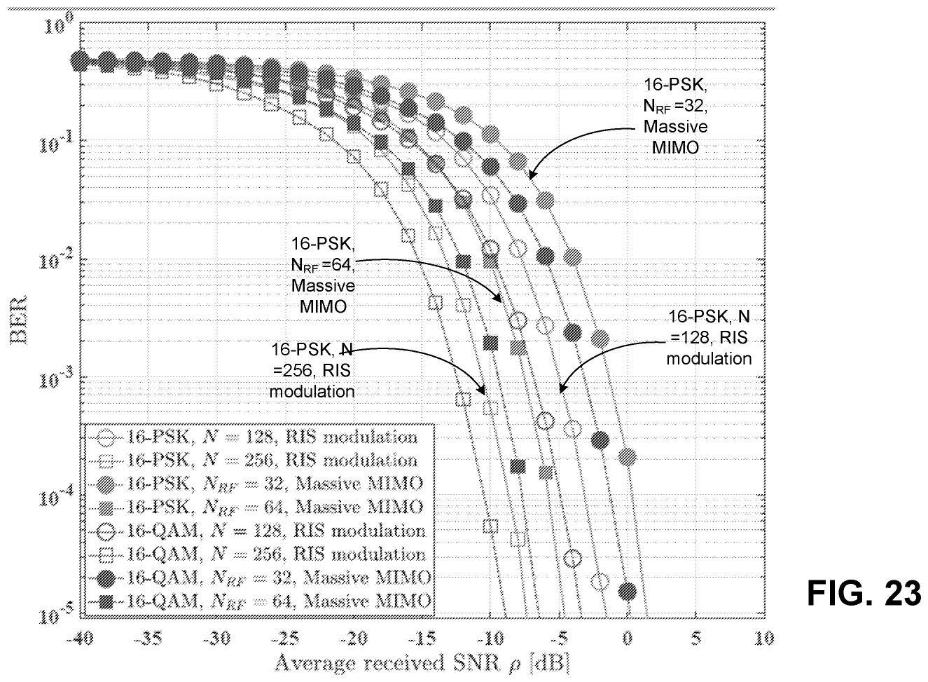

FIG. 23 shows an example of comparison of BER performance versus average received SNR p in the RIS-based transmitter and an MIMO example (e.g., the conventional massive MIMO), where the number of users is K=1 and the modulation schemes are 16-PSK and 16-QAM, respectively. The example in FIG. 23 shows that the RIS-based transmitter with N=128 passive reflecting elements outperforms the fully digital massive MIMO with N_{RF}=32 RF-chains. The RIS-based transmitter with N=256 passive reflecting elements outperforms some MIMO (e.g., the conventional fully digital massive MIMO) with N_{RF}=64 RF-chains. A single RF-chain (e.g., only a single RF-chain) may be equipped in the example RIS-based transmitter herein, which is, for example, efficient from the perspective of hardware complexity.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a processor configured to:
receive a channel state information reference signal (CSI-RS) associated with a reconfigurable intelligent surface (RIS), wherein the RIS comprises a plurality of active elements and a plurality of inactive elements;
determine, based on the CSI-RS, first channel vector information associated with the plurality of active elements;
determine, based on the first channel vector information, second channel vector information associated with the plurality of inactive elements;
generate a CSI reporting parameter based on the first channel vector information and the second channel vector information; and
send the generated CSI reporting parameter.

17. The WTRU of claim 16, wherein the processor is further configured to:
determine a channel matrix associated with the RIS, wherein the channel matrix indicates the first channel vector information and the second channel vector information, and wherein the CSI reporting parameter is generated using the channel matrix associated with the RIS.

18. The WTRU of claim 16, wherein the CSI reporting parameter is a virtual CSI reporting parameter, and the processor is further configured to:
receive configuration information associated with the RIS, wherein the configuration information indicates a configuration associated with the plurality of active elements and a configuration associated with the plurality of inactive elements;
determine a first channel matrix based on the first channel vector information; and
determine a second channel matrix based on the first channel matrix and the configuration information, wherein the second channel matrix indicates the first channel vector information and the second channel vector information, and wherein the virtual CSI reporting parameter is generated using the second channel matrix.

19. The WTRU of claim 18, wherein the first channel matrix comprises a first channel matrix coefficient associated with an element of the plurality of active elements, wherein the second channel matrix comprises the first channel matrix coefficient and a second channel matrix coefficient, and wherein the second channel matrix coefficient is associated with an element of the plurality of inactive elements.

20. The WTRU of claim 16, wherein the processor is further configured to:
perform, based on the CSI-RS, a channel measurement associated with one or more of the plurality of active elements, wherein the first channel vector information is determined based on the channel measurement.

21. The WTRU of claim 20, wherein the CSI reporting parameter is a second CSI reporting parameter and is associated with the plurality of active elements and the plurality of inactive elements, and the processor is further configured to:
determine a first CSI reporting parameter using the channel measurement associated with the one or more of the plurality of active elements; and
send at least one of the first CSI reporting parameter or the second CSI reporting parameter.

22. The WTRU of claim 16, wherein the processor is further configured to:
receive block division information associated with the RIS, wherein the block division information indicates that the RIS comprises a first block of elements and a second block of elements, wherein the first block of elements comprises the plurality of active elements and the plurality of inactive elements, and wherein the CSI reporting parameter is generated further based on the block division information and is associated with the first block of elements.

23. The WTRU of claim 16, wherein the processor is further configured to:
receive a request to communicate using a RIS-based transmission;
receive an indication of a plurality of transmission ports; and
decode the RIS-based transmission based on the indication of the plurality of transmission ports.

24. The WTRU of claim 16, wherein the RIS is associated with a transmitter, and the CSI-RS is received from the transmitter.

25. A method performed by a wireless transmit/receive unit (WTRU) comprising:
receiving a channel state information reference signal (CSI-RS) associated with a reconfigurable intelligent surface (RIS), wherein the RIS comprises a plurality of active elements and a plurality of inactive elements;
determining, based on the CSI-RS, first channel vector information associated with the plurality of active elements;
determining, based on the first channel vector information, second channel vector information associated with the plurality of inactive elements;
generating a CSI reporting parameter based on the first channel vector information and the second channel vector information; and
sending the generated CSI reporting parameter.

26. The method of claim 25, further comprising:
determining a channel matrix associated with the RIS, wherein the channel matrix indicates the first channel vector information and the second channel vector information, and wherein the CSI reporting parameter is generated using the channel matrix associated with the RIS.

27. The method of claim 25, wherein the CSI reporting parameter is a virtual CSI reporting parameter, and the method further comprises:
receiving configuration information associated with the RIS, wherein the configuration information indicates a configuration associated with the plurality of active elements and a configuration associated with the plurality of inactive elements;
determining a first channel matrix based on the first channel vector information; and
determining a second channel matrix based on the first channel matrix and the configuration information, wherein the second channel matrix indicates the first channel vector information and the second channel vector information, and wherein the virtual CSI reporting parameter is generated using the second channel matrix.

28. The method of claim 27, wherein the first channel matrix comprises a first channel matrix coefficient associated with an element of the plurality of active elements, wherein the second channel matrix comprises the first channel matrix coefficient and a second channel matrix coefficient, and wherein the second channel matrix coefficient is associated with an element of the plurality of inactive elements.

29. The method of claim 25, further comprises:
performing, based on the CSI-RS, a channel measurement associated with one or more of the plurality of active elements, wherein the first channel vector information is determined based on the channel measurement.

30. The method of claim 29, wherein the CSI reporting parameter is a second CSI reporting parameter and is associated with the plurality of active elements and the plurality of inactive elements, and the method further comprises:
determining a first CSI reporting parameter using the channel measurement associated with the one or more of the plurality of active elements; and
sending at least one of the first CSI reporting parameter or the second CSI reporting parameter.

31. The method of claim 25, further comprises:
receiving block division information associated with the RIS, wherein the block division information indicates that the RIS comprises a first block of elements and a second block of elements, wherein the first block of elements comprises the plurality of active elements and the plurality of inactive elements, and wherein the CSI reporting parameter is generated further based on the block division information and is associated with the first block of elements.

32. The method of claim 25, comprising:
receiving a request to communicate using a RIS-based transmission;
receiving an indication of a plurality of transmission ports; and
decoding the RIS-based transmission based on the indication of the plurality of transmission ports.

33. The method of claim 25, wherein the RIS is associated with a transmitter, and the CSI-RS is received from the transmitter.
